(19) United States
(12) Patent Application Publication
(10) Pub. No.: US 2009/0222387 A1
(43) Pub. Date: Sep. 3, 2009

(54) Diagnosis, Prognosis and Prediction of Recurrence of Breat Cancer

(76) Inventors: Mathias Gehrmann, Leverkusen (DE); Christian Von Törne, Solingen (DE)

Correspondence Address: Barbara A. Shimei;Director, Patents & Licensing, Bayer HealthCare LLC - Pharmaceuticals, 555 White Plains Road, Third Floor, Tarrytown, NY, 10591, US

(21) Appl. No.: 11/922,276

(22) PCT Filed: Jun. 14, 2006
(86) PCT No.: PCT/EP2006/005717

§ 371 Date: May 14, 2009

(30) Foreign Application Priority Data
Jun. 16, 2005 (GB) 0512299.9

(51) Int. Cl. G06F 15/18

(52) U.S. Cl. 706/12; 702/19

(57) ABSTRACT

The present invention relates to methods and compositions for the diagnosis, prognosis, and prediction of breast cancer. More specifically, the invention relates to classification of breast cancer tissue samples based on measuring the expression of a set of marker genes. The set is useful for the identification of clinically important breast cancer subtypes. Methods are disclosed for prediction, diagnosis and prognosis of breast cancer.

### TECHNICAL FIELD OF THE INVENTION

The present invention relates to methods and compositions for the diagnosis, prognosis, and prediction of breast cancer. More specifically, the invention relates to classification of breast cancer tissue samples based on measuring the expression of a set of marker genes. The set is useful for the identification of clinically important breast cancer subtypes. Methods are disclosed for prediction, diagnosis and prognosis of breast cancer.

### BACKGROUND OF THE INVENTION AND PRIOR ART

Breast cancer is one of the leading causes of cancer death in women in western countries. More specifically breast cancer claims the lives of approximately 40,000 women and is diagnosed in approximately 200,000 women annually in the United States alone. Over the last few decades, adjuvant systemic therapy has led to markedly improved survival in early breast cancer (EBCTCG, 1998 a+b). This clinical experience has led to consensus recommendations offering adjuvant systemic therapy for the vast majority of breast cancer patients (Goldhirsch et al., 2003). In breast cancer a multitude of treatment options are available which can be applied in addition to the routinely performed surgical removal of the tumor and subsequent radiation of the tumor bed. Three main and conceptually different strategies are endocrine treatment, chemotherapy and treatment with targeted therapies. Prerequisite for treatment with endocrine agents is expression of hormone receptors in the tumor tissue i.e. either estrogen, progesterone or both. Several endocrine agents with different mode of action and differences in disease outcome when tested in large patient cohorts are available. Tamoxifen is one of the oldest endocrine drugs that significantly reduced the risk of tumor recurrence. Apparently, even more effective are aromatase inhibitors which belong to a new endocrine drug class. In contrast to tamoxifen which is a competitive inhibitor of estrogen binding aromatase inhibitors block the production of estrogen itself thereby reducing the growth stimulus for estrogen receptor positive tumor cells. Recent clinical trials have demonstrated an even better disease outcome for patients treated with these agents compared to patients treated with tamoxifen. Still, some patients experience a relapse despite endocrine treatment and in particular these patients might benefit from additional therapeutic drugs. Chemotherapy with anthracyclines, taxanes and other agents have been shown to be efficient in reducing disease recurrence in estrogen receptor positive as well as estrogen receptor negative patients. The NSABP-20 study compared tamoxifen alone against tamoxifen plus chemotherapy in node negative estrogen receptor positive patients and showed that the combined treatment was more effective than tamoxifen alone. Recently, a systemically administered antibody directed against the Her2neu antigen on the surface of tumor cells have been shown to reduce the risk of recurrence several fold in a patients with Her2neu over expressing tumors.

Yet, most if not all of the different drug treatments have numerous potential adverse effects which can severely impair patients' quality of life (Shapiro and Recht, 2001; Ganz et al., 2002). This makes it mandatory to select the treatment strategy on the basis of a careful risk assessment for the individual patient to avoid over- as well as under treatment.

Arguably, the most important histopathological factor for risk stratification in primary breast cancer is the nodal status (Chia et al., 2004; Fisher et al., 1993; Jatoli et al., 1999). Patients with node-negative breast cancer have a favourable long-term prognosis with 10-years survival rates between 67% and 76% even without adjuvant systemic therapies (Fisher et al., 1993; Chia et al., 2004). To further elucidate the prognosis of this substantial subgroup of patients, several other factors such as the age of the patients, tumor size, estrogen receptor status and histological grade are commonly applied to identify those patients with only a minimal risk of recurrence (Chia et al., 2004). Only in these carefully selected patients can adjuvant systemic therapy be omitted without risk of under treatment (Goldhirsch et al., 2003). However, this group with a minimal risk comprises only very few of all node-negative breast cancer patients. An abundance of potential prognostic factors have been analysed in recent years often in studies with varying quality and sometimes conflicting results (Altman and Lyman, 1998).

More recently, gene expression profiling studies with DNA microarray technologies were able to show distinct subtypes of breast cancer (Perou et al., 2000). Five major subtypes described as luminal type A, luminal type B, basal like, Her2neu like and normal like tumors were identified by two dimensional hierarchical clustering. Luminal type A and B tumors were mainly estrogen receptor positive and basal like tumors estrogen receptor negative. Importantly, in survival analysis the subtypes showed significantly differences in outcome with the basal like and Her2neu tumors having the worst outcome and with luminal like A patients having the best outcome (Sorlie et al, 2001, 2003). However, this “class discovery” approach based on unsupervised two dimensional hierarchical cluster analysis appeared not to be effective for class prediction. First, by this technique tumor samples are ordered in a row according to the calculated similarity and slight variations of the algorithm or distance metrics can result in large differences of sample orders. In addition, inclusion of a few additional samples can have tremendous influence on sample order so that a robust and reproducible classification is difficult. Furthermore, cluster of genes related to putative clinical relevant tumor subclasses have been identified by visual inspection instead of appropriate statistical evaluation. Consequently, neither discovered classes nor genes selected to characterize them allow reproducible and robust classification.

Expression profiles could be linked to prognosis by several investigators using supervised analysis methods that are assumed to be more appropriate for class prediction studies. Van't Veer et al. identified a prognostic signature consisting of 70 respectively 231 genes in a finding cohort of 78 sporadic breast cancers of node negative women younger than 53 years of age (Van't Veer et al., 2002; Van de Vijver et al., 2002). They used a case versus control statistics, with development of metastasis within five years defined as case and disease free survival of more than five years as control, and found that the expression values of at least 70 genes could be used to calculate an average “good prognosis” profile. Unknown tumor samples were classified by correlation of the gene expression of these 70 genes to the good prognosis signature. In a subsequent validation study the significance as a predictor of survival was confirmed (Van de Vijver et al., 2002) although a multicenter external validation study showed that the predictor performed less well as previously published (Piccart et al., SABC presentation 2004). Huang et al., 2003 described gene expression predictors of lymph node status and recurrence. They used k-means clustering of 7030 genes with a target of 500 clusters. For all resulting 496 clusters the dominant singular factor was obtained and used as “metagene” in a tree model analysis. They noted that poor outlook with respect to survival is related to the vigorous proliferative ability of the tumor. Aggregates of distinct groups of genes were capable of predicting lymph node status and patient outcome at least in the small cohort which was used in the analysis. Distinct gene expression alterations were found to be associated with different tumor grades (Ma et al., 2003). Grade I and grade III breast tumors exhibit reciprocal gene expression patterns, whereas grade II tumors exhibit a hybrid pattern of grade I and grade III signatures. Similarly, a gene expression signature differentiating grade I versus grade II tumors was found by another group using a high density single colour gene expression platform. Using this signature, which they called “Genomic Grade Index (GGI)” they showed that the GGI could stratify histological grade II tumors into tumors resembling either more genomic grade I or genomic grade III tumors (Sotiriou et al., 2005). ER-alpha (ER) status is an essential determinant of clinical and biological behaviour of human breast cancers. Generally, patients with ESR1-negative tumors tend to have a worse prognosis than patients with ESR1-positive tumors. The underlying reason for this phenomenon is probably the large genetic difference between these two distinct tumor subtypes. Several gene expression studies found that numerous genes are tightly co-regulated with the estrogen receptor and that the estrogen receptor status might be more reliably determined by measuring ESR1 mRNA than the protein by immunohistochemistry (Dressman et al., 2001). In a previous study two prognostic gene expression profiles have been identified for ER-positive and ER-negative tumors, respectively (Wang et al. 2005). The ER status had been determined by ligand binding assay or immuno-histochemistry. Expression values of 60 probe sets measured by Affymetrix HG U133A oligonucleotide gene chips for ER-positive samples and 16 probe sets for ER-negative samples were used to classify separately both tumor types into a high and low risk prognostic class.

Gene expression profiling not only has been utilized for identification of prognostic genes but also for development of classification algorithms capable of predicting response of a tumor toward a given drug treatment. Gene signatures and corresponding algorithms have been identified for predicting tumor response toward docetaxel based on a 92 gene predictor (Chang et al. 2003), paclitaxel followed by fluorouracil, doxorubicin and cyclophosphamide using a model based on expression values of 74 genes (Ayers et al. 2004) or tamoxifen using a 44 gene signature (Jansen et al. 2005) and a 62 probe set signature (Loi et al., 2005) respectively. In another study, gene expression profiles of tumors of tamoxifen treated patients were used to define a two-gene ratio supposed to be predictive of disease free survival (Ma et al., 2004). However, neither the 44 gene signature nor the two-gene ratio proposed to predict response to tamoxifen could be validated in a subsequent study (Loi et al., 2005). A multigene assay comprising the measurement of 21 genes (16 breast cancer related genes and 5 housekeeping genes) was shown to predict recurrence of tamoxifen-treated breast cancer (Paik et al. 2004). The genes were selected from a limited list of genes derived from the literature and tested for prognostic and predictive power by expression profiling in patient samples. However, since the genes tested comprise only a minor subset of all genes expressed in breast tumour tissue and the panel of 16 breast cancer related genes is strongly biased in that it predominantly measures the degree of proliferation, it is highly likely, that a more comprehensive gene expression profiling approach will yield a better predictor.

Most gene identification methods use per-gene (univariate) statistics such as t-test (Chang et al. 2003), signal to noise ratio (Golub et al. 1999), significance analysis in microarrays SAM (Tusher et al., 2001) or univariate Cox regression (Wang et al. 2005). In recent years, multivariate models have become increasingly popular (Shrunken Centroids (Tibshirani et al., 2001, 2002), KNN (Khan et al. 2002), SVM (Lee 2000, 2001), Artificial Neural Networks (Burke et al., 1995), multivariate Cox Regression (Pawitan et al., 2004; van de Vijver et al., 2002; Li et al., 2003)). The goals remain the same as in the univariate context: to distinguish between two or more different classes and to produce a predictor that can assign a class to a given previously unknown sample while using a minimal set of genes only. Since multivariate models usually allow for geometrically more complex separations, the issue of overfitting the data arises. This is especially a problem if the model has a lot of parameters to be estimated from the training data. Selection of the minimal number of genes needed to successfully capture the nature of the subclasses is also somewhat arbitrary (up to the point of over-fitting the training data) since higher testset accuracy can possibly be achieved by allowing the use of a larger number of genes in the predictor. A disadvantage of most studies using the standard strategy of supervised gene identification is the fact that the corresponding algorithms utilize a high number of genes that are potentially unstable as predictors in the general population. The main reason for this problem can be ascribed to the way how the genes of the classifier are selected. In most cases the number of expression levels measured (p) will exceed the number of patient samples (n) by orders of magnitude (n<<p) so that the selected genes and algorithms are highly prone to over estimating the quality of predictor performance, because the molecular signatures strongly depended on the selection of patients in the gene finding cohort, which may not adequately represent the patient population the classifier is intended for. For instance, with data from the study by van't Veer and colleagues and a gene finding set of the same size as in the original publication (n=78), only 14 of 70 genes from the published signature were included in more than half of 500 signatures generated after multiple randomisation of the training set, although virtually the same gene finding algorithm was used, namely Pearson correlation with binary patient status (Michiels et al. 2005). Furthermore, samples apparently belonging to a different clinical class, e.g. a sample from a patient with an early distant metastasis and another sample from a patient with no metastasis for many years after diagnosis, still might be very similar with regard to their gene expression pattern. The underlying reasons for the different behaviour of tumors with very similar expression profiles might be subtle and difficult to correlate to gene expression. In any case, all these aspects make it very difficult to extract the most informative genes and to build a high performance classifier.

### SUMMARY OF THE INVENTION

The present invention is based on the unexpected finding that robust classification of breast tumor tissue samples into clinically relevant subgroups can be achieved by predictors that use a small set of specific marker genes. The idea of the invention is to predict the class of a previously unknown tissue sample (i.e. its gene expression profile) hierarchically by separating a number of mutually disjoint groups of classes at a time (FIG. 1). In each node in this tree (where a partial classification is done), only a very small number of genes is used to reliably distinguish the classes or groups of classes until the sample can uniquely be assigned to a single class (the leaves of the tree structure). One embodiment of the method uses a hierarchical binary classification technique (n=2) involving the computation of in-class-probability for each sample point to each class. In another embodiment, the approach is able to cope with an arbitrary number of classes (n>2) at the same time. The whole set of partial classifiers builds the global classifier. The number of genes used in each partial classifier can be as low as 2, but also larger numbers of genes may be used.

It is an unexpected finding that the overall predictor is robust in the sense that in a random permutation of the sample-to-class mapping for each partial classifier, the best possible classifier on the original data is significantly better than the best one on randomized data.

Compared to the supervised methods mentioned in the previous section, the classification method described in the invention is capable to distinguish between tumours that are genetically very different yet behave very similar with regard to a particular clinical parameter. Furthermore, it uses a much smaller set of genes for class separations and achieves a significantly higher accuracy on test data. In that respect, it out-performs prior classifiers. Special gene sets are provided for the classification of a breast tumor sample into clinically relevant subclasses.

The method comprises:

a) Measuring the expression of genes in a collection of breast tumor specimens.

b) Normalising the raw signal intensities of the gene measurements of each individual array using either signal intensities of housekeeping genes measured on the same array or a global scaling approach, in which all signal intensities of an array multiplied with a factor so that the signal intensities of all arrays of the experiment have the same median (or mean).

c) Filtering for those genes that first, are technically well measurable, e.g. with a median signal intensity higher than background signal+3 standard deviations of repeated background measurements and secondly, variable expressed within said specimen collection, e.g. having a coefficient of variation of larger than 5% for log transformed expression values.

d) Performing an unsupervised principle component analysis (PCA) on conditions (samples) using the selected genes with appropriate computer programs like GeneSpring® (Silicon Genetics, Redwood City, Calif., USA).

e) Displaying the PCA outcome in a two or preferentially three dimensional condition scatter graph using preferentially principal components 1, 2 and 3 (FIG. 1a).

f) Visualising categorical clinical information, e.g. estrogen receptor status, presence and absence of metastasis, clinical grade, or histological tumor type, or numerical clinical information, e.g. time to metastasis, time to local recurrence, or age, in the graphical display, e.g. by colouring the respective classes by discrete or continuous colouring, respectively (FIG. 1b).

g) Identifying clinically relevant subclasses by I) similar clinical characteristics only, II) by similar clinical characteristics and mutual proximity within the PCA. In accordance to f), similarity in clinical characteristics is visualised by similar colours, so it is easy to extract from the visualisation (FIG. 1c).

h) Labelling of the samples according to the identified subclasses. Clinically relevant breast cancer subclasses that have been identified include:
Estrogen receptor positive breast tumours with a
i. very low likelihood for disease recurrence (FHL++)
ii. low likelihood for disease recurrence (FHL+, FHL++, ESR1++)
iii. high likelihood for disease recurrence (ESR1 LM, ESR1 EM, ESR1 ER)
iv. high likelihood for early disease recurrence (ESR1 ER, ESR1 EM)
v. high likelihood for late disease recurrence (ESR1 LM)
vi. high likelihood for early distant metastasis (ESR1EM), (FIG. 1d)
vii. high likelihood for early local recurrence (ESR1 ER)
Estrogen receptor negative breast tumors with a
viii. low likelihood for disease recurrence (ESR-A)
ix. high likelihood for disease recurrence (ESR-B)
x. intermediate likelihood for disease recurrence (ESR-C, ESR-D)

i) Identifying genes suitable for classification of said breast cancer subclasses using t-statistics, signal to noise ratio, fishers exact test, support vector machines or any other method previously described to derive separating genes. Special preference is put on genes whose median expression level across all samples in the collection is above the lower quartile of the medians of all genes measured.

j) In particular, said subclasses may be characterized on the gene expression level by fitting multivariate normal distributions to each subclass, either with distinctly, partial commonly or commonly chosen or estimated distribution parameters, and selecting a prediction class for a previously unknown sample based on the probability distributions and/or pointwise probability of the gene expression values of the sample under investigation used in the distributions of the training clusters (including, but not limited to e.g. the likeliest cluster).

k) Said algorithm may use 2 or more genes or means or medians of gene sets derived prior to classifier training by a grouping procedure such as but not limited to unsupervised clustering or correlation graph analysis.

l) Said algorithm may in parts use univariate gene expression distributions and/or values of single genes, medians or means of gene sets previously derived for partial classification. “Estrogen receptor positive” and “estrogen receptor negative”, within the meaning of the invention, relates to the classification of tumors to one of the classes based on methods like immunohistochemistry (IHC), ligand binding assay (DCC) or ESR1 mRNA measurement of preferentially micro-dissected or macro-dissected tumor tissue.

### BRIEF DESCRIPTION OF THE FIGURES

FIG. 1a depicts the result of an unsupervised principle component analysis of 212 breast tumour samples using variable expressed genes.

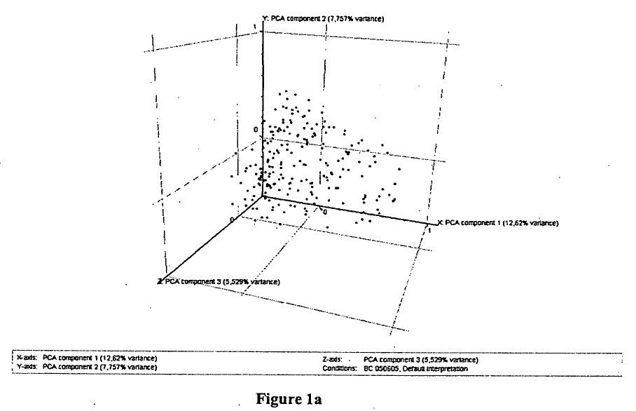

FIG. 1b depicts the result of an unsupervised principle component analysis of 212 breast tumor samples using variable expressed genes coloured according to ESR1 status (1 if signal intensity>1000, 0 if signal intensity ≦1000).

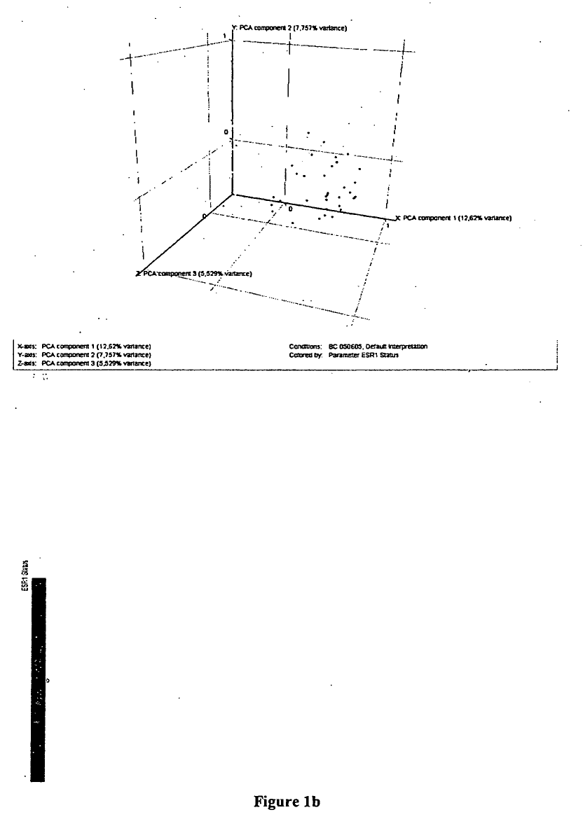

FIG. 1c depicts the results of an unsupervised principle component analysis of 212 breast tumor samples using variable expressed genes coloured according to time to metastasis (TTM). Samples without metastasis are set to 180 regardless of follow up time.

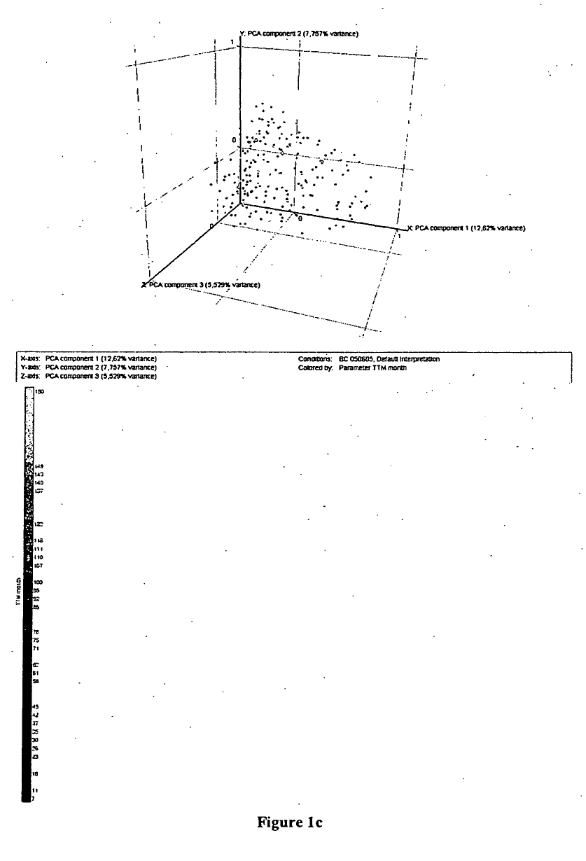

FIG. 1d depicts the results of an unsupervised principle component analysis of 212 breast tumor samples using variable expressed genes. A subgroup of estrogen receptor positive tumors with a high likelihood of early metastasis has been labelled (ESR+ EM) based on information provided in FIGS. 1b and 1c.

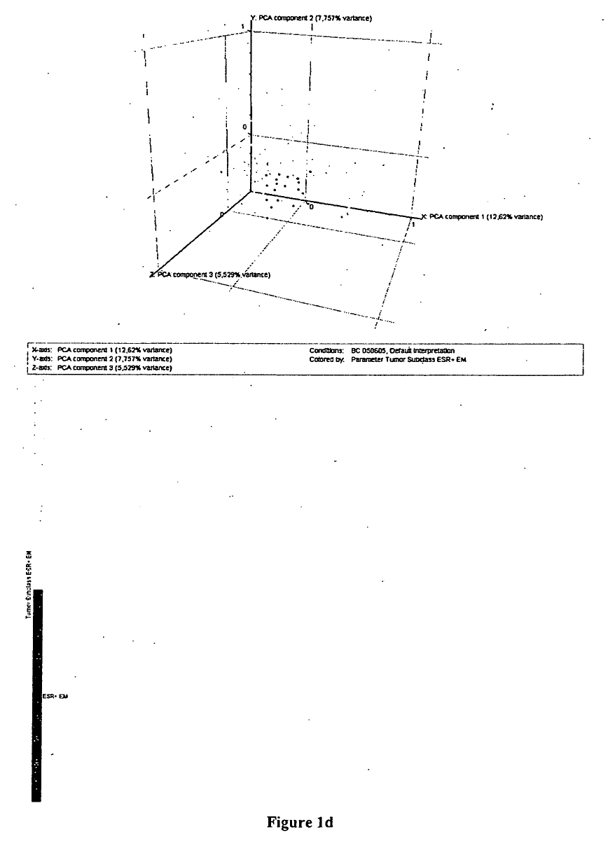

FIG. 2 depicts an example of a hierarchical classification tree.

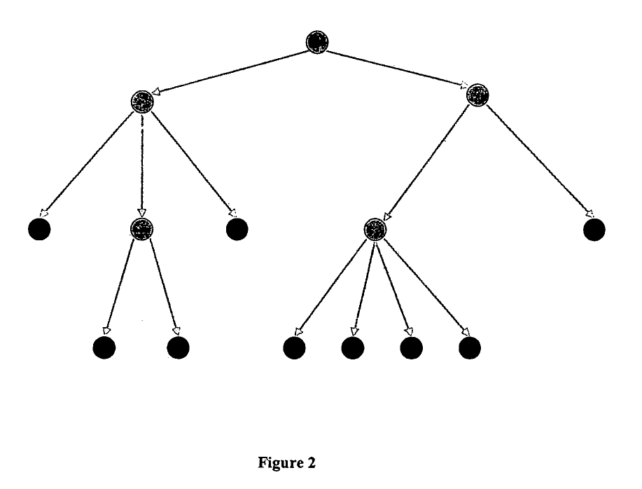

FIG. 3 depicts the separation scheme used for an embodiment of the invention.

FIG. 4 depicts the separation scheme used for an embodiment of the invention with reference numerals.

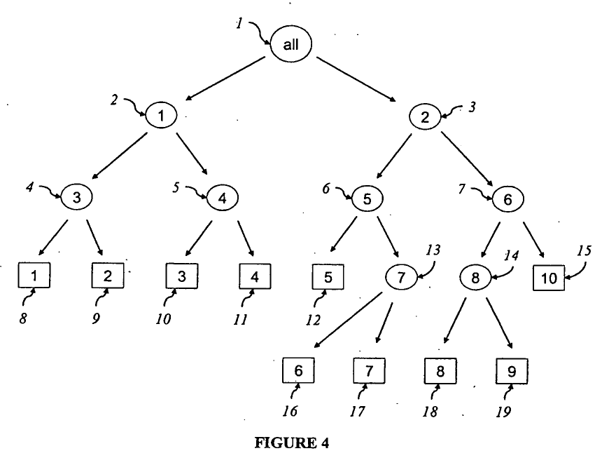

### DETAILED DESCRIPTION OF THE INVENTION

The present invention relates to a method of building a classificator for the classification of breast cancer samples into clinically relevant sub-classes, said method comprising

(a) collecting data on the expression level of a plurality of genes in a plurality of breast tumor samples,

(b) performing an unsupervised principle component analysis on data derived from said data collected under (a),

(c) visualizing the outcome of said principle component analysis under (b),

(d) visualizing categorical clinical information for individual samples in said visualization of step (c),

(e) identifying clinically relevant sub-classes as regions in said visualization of step (d),

(f) identifying marker genes and threshold values for expression levels of said marker genes, suitable for classification of said breast cancer samples into said clinically relevant breast cancer classes.

The present invention further relates to methods of building a classificator for the classification of breast cancer samples into clinically relevant sub-classes, wherein said classification of said breast cancer samples is in a hierarchical classification tree.

Methods of the invention are preferably built exclusively from binary classification steps.

According to another aspect of the invention, said data derived from said data collected under step (a) is obtained by normalization of said collected data.

According to another aspect of the invention, the method further comprises filtering for genes that are technically well measurable and/or variably expressed in said plurality of breast tumor samples.

According to another aspect of the invention said visualization is a visualization of a three-dimensional space, spanned by the first three principle components of said principle component. analysis.

Preferably, said visualization of said categorical clinical information is by using a color code, a symbol code and/or a size code. Different categories are assigned different colors, different shapes (i.e. different symbols), or different sizes of the symbols used for visualization of the PCA results.

The present invention also relates to a system for building a classificator for the classification breast cancer samples into clinically relevant sub-classes, said system being adapted to perform methods of the invention as described above.

Such systems advantageously comprise

(a) means for performing an unsupervised principle component analysis on data derived from gene expression data,

(b) means for visualizing the outcome of said principle component analysis under (a) in a multidimensional space,

(c) means for visualizing categorical clinical information of individual samples in said visualization of (b).

Another aspect of the invention relates to a method for the classification of a breast cancer from a sample of said tumor, said method comprising

(a) assigning the sample to a first aggregate breast cancer class (2) if the sample is ESR(+), or to a second aggregate breast cancer class (3) if the sample is ESR(−),

(b) if said sample is in the first aggregate breast cancer class (2), then
(i) assigning the sample to a 3rd (4) or a 4th (5) aggregate breast cancer class, based on marker gene expression;
(ii) if said sample is in the 3rd aggregate breast cancer class (4), then assigning the sample to a first (8) or a second (9) elementary breast cancer class, based on marker gene expression;.
(iii) if said sample is in the 4th aggregate breast cancer class (5), then assigning the sample to a third (10) or a fourth (11) elementary breast cancer class, based on marker gene expression;

(c) if said sample is in the second aggregate breast cancer class (3), then
(i) assigning the sample to a fifth (6) or a 6th (7) aggregate breast cancer class, based on marker gene expression,
(ii) if said sample is in the fifth aggregate breast cancer class (6), then assigning the sample to a fifth elementary breast cancer class (12) or a 7th aggregate breast cancer class (13), based on marker gene expression,
(iii) if said sample is in said 7th aggregate breast cancer class (13), then assigning the sample to a 6th (16) or 7th (17) elementary breast cancer class
(iv) if said sample is in said 6th aggregate breast cancer class, then assigning said sample to an 8th aggregate breast cancer class (14) or to a 10th elementary breast cancer class (15),
(v) if said sample is in said 8th aggregate breast cancer class (14), then assigning said sample to an 8th (18) or 9th (19) elementary breast cancer class.

Another aspect of the invention relates to the method described above, wherein

(a) said assigning said sample to a 3rd (4) or 4th (5) aggregate breast cancer class is based on a bivariate classifier using the expression level of two genes selected from Table 1,

(b) said assigning said sample to a first (8) or second (9) elementary breast cancer class is based on a bivariate classifier using the expression level of two genes selected from Table 2,

(c) said assigning said sample to a 3rd (10) or 4th (11) elementary breast cancer class is based on a bivariate classifier using the expression level of two genes selected from Table 3,

(d) said assigning said sample to a 5th (6) or 6th (7) aggregate breast cancer class is based on a bivariate classifier using the expression level of two genes selected from Table 4,

(e) said assigning said sample to a 5th elementary breast cancer class (12) or a 7th aggregate breast cancer class (13) is based on a bivariate classifier using the expression level of two genes selected from Table 5,

(f) said assigning said sample to a 6th (16) or 7th (17) elementary breast cancer class is based on a bivariate classifier using the expression level of two genes selected from Table 6,

(g) said assigning said sample to an 8th aggregate breast cancer class (14) or a 10th elementary breast cancer class (15) is based on a bivariate classifier using the expression level of two genes selected from Table 7,

(h) said assigning said sample to an 8th (18) or 9th (19) elementary breast cancer class is based on a bivariate classifier using the expression level of two genes selected from Table 8.

Another aspect of the invention relates to the above methods, wherein

(a) said assigning said sample to a 3rd (4) or 4th (5) aggregate breast cancer class is based on a bivariate classifier using the expression level of two genes selected from the group consisting of 21821_s_at, 213441_x_at, 214404_x_at and 220192_x_at and 208190_s_at, or selected from the group consisting of 219572_at, 204641_at, 207828_s_at and 219918_s_at, or selected from the group consisting of 202580_x_at, 221436 s_at, 202035_s_at, 202036_s_at and 202037_s_at;

(b) said assigning said sample to a first (8) or second (9) elementary breast cancer class is based on a bivariate classifier using the expression level of 206978_at and 203960_s_at or the absolute expression level of 204502_at and 214433_s_at, or the absolute expression level of 209374_s_at or 206133_at;

(c) said assigning said sample to a 3rd (10) or 4th (11) elementary breast cancer class is based on a bivariate classifier using the expression level of two genes selected from the group consisting of 209392_at, 210839_at, 209135_at and 210896_s_at, or selected from the group consisting of 219777_at and 213508_at, or selected from the group consisting of 218806_s_at, 218807_at and 208370_s_at;

(d) said assigning said sample to a 5th (6) or 6th (7) aggregate breast cancer class is based on a bivariate classifier using the absolute expression level of 208747_s_at and 38158s_at, or 216401_x_at and 204222_s_at, or 214768_x_at and 202238_s_at;

(e) said assigning said sample to a 5th elementary breast cancer class (12) or a 7th aggregate breast cancer class (13) is based on a bivariate classifier using the expression level of 213288_at and 204897_at, or the expression level of two genes selected from the group consisting of 203868_s_at, 203438_at and 203439_s_at, or the expression level of 209374_s_at and 203895_at;

(f) said assigning said sample to a 6th (16) or 7th (17) elementary breast cancer class is based on a bivariate classifier using the absolute expression level of two genes selected from the group consisting of 218468_s_at, 218469_at, 203438_at and 203439_s_at, or selected from the group consisting of 201656_at, 215177_s_at and 201627_s_at, or selected from 219197_s_at and 209291_at;

(g) said assigning said sample to an 8th aggregate breast cancer class (14) or a 10th elementary breast cancer class (15) is based on a bivariate classifier using the absolute expression level of two genes selected from the group consisting of 205479_s_at, 211668_s_at, 203797_at, or selected from the group consisting of 212935_at and 212494_at, or selected from the group consisting of 221530_s_at and 202177_at;

(h) said assigning said sample to an 8th (18) or 9th (19) elementary breast cancer class is based on a bivariate classifier using the absolute expression level of two genes selected from the group consisting of 209714_s_at and 204259_at, or selected from 209200_at and 204041_at, or selected from the group consisting of 202954_at, 208079_s_at, 204092_s_at and 218644_at.

Further aspects of the invention are shown in by way of the following examples.

### EXAMPLES

### Example 1

### Isolation of RNA From Tumor Tissue

RNA Isolation From Frozen Tumour Tissue Sections

Frozen sections were taken for histology and the presence of breast cancer was confirmed in samples from 212 patients. Tumor cell content exceeded 30% in all cases and was above 50% in most cases. Approximately 50 mg of snap frozen breast tumour tissue was crushed in liquid nitrogen. RLT-Buffer (QIAGEN, Hilden, Germany) was added and the homogenate spun through a QIAshredder column (QIAGEN, Hilden, Germany). From the eluate total RNA was isolated by the RNeasy Kit (QIAGEN, Hilden, Germany) according to the manufacturers instruction. RNA yield was determined by UV absorbance and RNA quality was assessed by analysis of ribosomal RNA band integrity on the Agilent Bioanalyzer (Palo Alto, Calif., USA).

### Example 2

### Determination of Expression Levels

Gene Expression Measurement Utilizing HG-U133A Microarrays of Affymetrix

Starting from 5 μg total RNA labelled cRNA was prepared for all 212 tumour samples using the Roche Microarray cDNA Synthesis, Microarray RNA Target Synthesis (T7) and Microarray Target Purification Kit according to the manufacturer's instruction. In brief, synthesis of first strand cDNA was done by a T7-linked oligo-dT primer, followed by second strand synthesis. Double-stranded cDNA product was purified and then used as template for an in vitro transcription reaction (IVT) in the presence of biotinylated UTP. Labelled cRNA was hybridized to HG-U133A arrays (Santa Clara, Calif., USA) at 45° C. for 16 h in a hybridization oven at a constant rotation (60 r.p.m.) and then washed and stained with a streptavidin-phycoerythrin conjugate using the GeneChip fluidic station. We scanned the arrays at 560 nm using the GeneArray Scanner G2500A from Hewlett Packard. The readings from the quantitative scanning were analysed using the Microarray Analysis Suit 5.0 (MAS 5.0) from Affymetrix. In the analysis settings the global scaling procedure was chosen which multiplied the output signal intensities of each array to a mean target intensity of 500. Array images were visually inspected for defects and quality controlled using the Refiner Software from GeneData. Routinely we obtained over 50 percent present calls per chip as calculated by MAS 5.0.

### Example 3

### Labelling of Breast Cancer Samples into Subclasses After Principle Component Analysis

All 212*.chp files generated by MAS 5.0 were converted to *.txt Files and loaded into GeneSpring® software (Silicon Genetics, Redwood City, Calif., USA). An experiment group was created using the following normalisation settings. Values below 0.01 were set to 0.01. Each measurement was divided by the 50th percentile of all measurements in that sample. Each gene was divided by the median of its measurements in all samples. If the median of the raw values was below 10 then each measurement for that gene was divided by 10 if the numerator was above 10, otherwise the measurement was thrown out. Next, genes were filtered for quality with regard to the technical measurement. In a first step genes from the default list “all genes”. whose flags in the experiment group were “Present” in at least 10 of the 212 samples were selected for further analysis. Secondly, remaining genes were filtered for variable expression within the experiment group. For that purpose only genes were considered eligible for further analysis when the normalized signal intensity was above 3 or below 0.3 in at least 10 of the 212 samples. Several other cut off values used for filtering of variable genes as well as choosing genes on the basis of coefficient of variation calculations (e.g. >5% for log 2 transformed signal intensities) yielded gene list of similar usefulness for subsequent principal component analysis (PCA).

### Example 4

### Classification of Breast Cancer Samples Into Subclasses From Expression Levels of Marker Genes

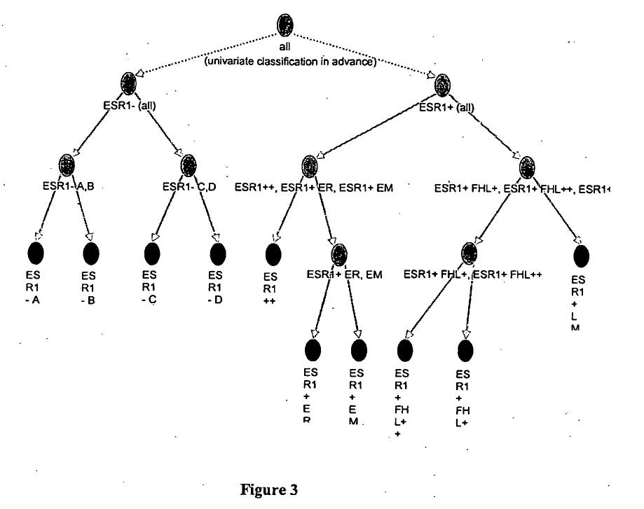

1. The overall classifier on the breast cancer data (n=212 samples (tissue samples) with p˜22k gene expression levels each) was derived in the following steps:
a) A separation of the samples was carried out by distinguishing estrogen receptor negative and estrogen receptor positive samples by comparing the absolute, relative or standardized expression level of an estrogen related gene with a thresholding value. In an embodiment of the algorithm, the gene ESR1 was used with a threshold of 1000, yielding estrogen receptor state negative (called ESR− from now on) for ESR1 expressions smaller than 1000 and estrogen receptor state positive (called ESR+ from now on) for ESR1 expressions greater or equal to 1000.
b) For the both groups (ESR+ and ESR−) separately, genes with advantageous properties were identified in an unsupervised manner including general quality measures like present calls, minimum expression, minimum median expression, minimum mean expression, standardized variance, normal variance, signal-to-noise ratio and by other means on the raw or processed data (e.g. logarithmized data). In an embodiment of the method, genes were selected to be present in at least 5 samples, to have a minimum mean expression of 250 and a standardized standard deviation exceeding 8% for logarithmised data.
c) For each partial predictor, genes may be used single or in groups, where groups of genes are replaced by one or more quantity derived from the group member genes by linear or nonlinear functions of the member genes, including (but not limited to) means, medians, minimum and maximum values or principal components. In an embodiment of the method, genes sets were “pooled” to increase overall stability and take advantage of redundancy of the underlying genetic network. Clusters of co-expressed genes that had a complete correlation graph in terms of Pearson correlation to a minimum threshold of 0.8 were identified. Each “pool” of genes was replaced by a single value (for each tissue sample) by taking the arithmetic average expression of all genes in the pool.
d) A separation strategy was chosen by grouping sample labels (e.g. ESR− A,B as one group and ESR− C,D as another). The separation may use a strictly hierarchical approach, direct classification or majority decisions using sets of multiple partial classifiers. In an embodiment of the method, a strictly hierarchical separation strategy was chosen as illustrated in FIG. 3.
e) Each partial separation inside ESR− and ESR+ uses a multivariate per-class normal distribution to assign a class to an unknown tissue sample as described in items i), j), k) in the Summary of the Invention chapter. In an embodiment of the method, bivariate normal distributions were used to estimate pointwise in-class probabilities of an unknown sample.
f) The parameters of the multivariate distributions can be estimated from the all of the data or a subset thereof using standard statistic methods such as (but not limited to) arithmetic mean (over samples) and covariance (over samples). The parameters of the distribution may be estimated simultaneously (i.e. the value under consideration is expected to be constant over two or more classes) or separately (i.e. the value under consideration is estimated in each class separately). In an embodiment of the method, the mean and the covariance of the distribution were estimated for each class separately.
g) Parameters for the distributions may be selected by exhaustive search, steepest descent or other optimization techniques known to a scientist skilled in the art of mathematics with respect to one or more objectives measuring the performance (quality) of each possible classifier. Parameters include linear and nonlinear mappings of one or more gene expression levels. In an embodiment of the method, exhaustive search with respect to the selection of two different gene pools in the meaning of item c) was performed with the objective of minimizing the arithmetic mean of 100 ten-fold cross validation test set misclassification rates. If this objective did not yield a unique (partial) classifier, cross entropy (misclassification error) was computed for the predicted and true classes of the test set samples, and the predictor with the lowest cross entropy was chosen.
h) With the optimal set of genes determined by g), parameters of the final partial classifier distribution may be estimated in a way described in f) using either the full or a partial set of available samples. In an embodiment of the method, mean and covariance of the bivariate normal distribution was estimated for each class separately by using all samples bearing the labels under discussion in the partial classifier.

For the separation of (ESR1− A, ESR1− B) against (ESR1− C, ESR1− D), the following partial classifier is used:
i) With g₁ being the mean of the binary logarithm of the absolute expression levels of genes 218211_s_at, 213441_x_at, 214404_x_at, and 220192_x_at, and g₂ being the binary logarithm of the absolute expression level of gene 208190_s_at, evaluate

$$\begin{matrix} {p}_{1} := \frac{1}{\sqrt{{( 2 \cdot π )}^{2} \cdot \vert det {Σ}_{1} \vert}} \cdot exp ( - \frac{1}{2} \cdot {( g - {μ}_{1} )}^{t} {Σ}_{1}^{- 1} g - {μ}_{1} ) \\ {p}_{2} := \frac{1}{\sqrt{{( 2 \cdot π )}^{2} \cdot \vert det {Σ}_{2} \vert}} \cdot exp ( - \frac{1}{2} \cdot {( g - {μ}_{2} )}^{t} {Σ}_{2}^{- 1} ( g - {μ}_{2} ) ) \\ with \\ g := ( \begin{matrix}{g}_{1} \\ {g}_{2}\end{matrix} ) , {μ}_{1} := ( \begin{matrix}7.69 \\ 10.39\end{matrix} ) , {μ}_{2} := ( \begin{matrix}10.53 \\ 9.96\end{matrix} ) , \\ {Σ}_{1} := ( \begin{matrix}0.80 & - 0.073 \\ - 0.073 & 0.32\end{matrix} ) , {Σ}_{2} := ( \begin{matrix}1.37 & 0.71 \\ 0.71 & 0.92\end{matrix} )\end{matrix}$$

If p₁>p₂, we assign the unknown sample to the first group of clusters, ESR1− A, ESR1− B, and if not, to the second group of clusters, ESR1− C, ESR1− D.
ii) Another choice for genes, μ₁, μ₂, Σ₁, and Σ₂ is g₁: binary logarithm of raw expression values of 219572_at, g₂: mean of binary logarithms of raw expression values of 204641_at, 207828_s_at, and 219918_s_at, and

$${μ}_{1} := ( \begin{matrix}8.06 \\ 9.78\end{matrix} ) , {μ}_{2} := ( \begin{matrix}9.57 \\ 8.48\end{matrix} ) , \\ {Σ}_{1} := ( \begin{matrix}0.48 & 0.0078 \\ 0.0078 & 0.41\end{matrix} ) , {Σ}_{2} := ( \begin{matrix}0.44 & 0.17 \\ 0.17 & 0.99\end{matrix} )$$

iii) Another choice for genes, μ₁, μ₂, Σ₁, and Σ₂ is g₁: mean of binary logarithms of raw expression values of 202580_x_at and 221436_s_at, g₂: mean of binary logarithms of raw expression values of 202035_s_at, 202036_s_at and 202037_s_at, and

$${μ}_{1} := ( \begin{matrix}9.49 \\ 10.76\end{matrix} ) , {μ}_{2} := ( \begin{matrix}8.12 \\ 8.18\end{matrix} ) , \\ {Σ}_{1} := ( \begin{matrix}0.37 & 10.76 \\ 0.37 & - 0.33\end{matrix} ) , {Σ}_{2} := ( \begin{matrix}0.66 & - 0.28 \\ - 0.28 & 2.33\end{matrix} )$$

For the separation of (ESR1− A) against (ESR1− B), the following partial classifier is used:
i) With g₁ being the binary logarithm of the absolute expression level of 206978_at and g₂ being the binary logarithm of the absolute expression level of 203960_s_at evaluate

$$\begin{matrix} {p}_{1} := \frac{1}{\sqrt{{( 2 \cdot π )}^{2} \cdot \vert det {Σ}_{1} \vert}} \cdot exp ( - \frac{1}{2} \cdot {( g - {μ}_{1} )}^{t} {Σ}_{1}^{- 1} ( g - {μ}_{1} ) ) \\ {p}_{2} := \frac{1}{\sqrt{{( 2 \cdot π )}^{2} \cdot \vert det {Σ}_{2} \vert}} \cdot exp ( - \frac{1}{2} \cdot {( g - {μ}_{2} )}^{t} {Σ}_{2}^{- 1} ( g - {μ}_{2} ) ) \\ with \\ g := ( \begin{matrix}{g}_{1} \\ {g}_{2}\end{matrix} ) , {μ}_{1} := ( \begin{matrix}8.68 \\ 8.61\end{matrix} ) , {μ}_{2} := ( \begin{matrix}7.48 \\ 8.29\end{matrix} ) , \\ {Σ}_{1} := ( \begin{matrix}0.56 & - 0.20 \\ - 0.20 & 0.55\end{matrix} ) , {Σ}_{2} := ( \begin{matrix}0.23 & - 0.034 \\ - 0.034 & 0.18\end{matrix} )\end{matrix}$$

If p₁>p₂, we assign the unknown sample to the first cluster, ESR1− A, and if not, to the second cluster, ESR1− B.
ii) Another choice for genes, μ₁, μ₂, Σ₁, and Σ₂ is g₁: binary logarithm of raw expression value of 204502_at, g₂: binary logarithm of raw expression value of 214433_s_at, and

$${μ}_{1} := ( \begin{matrix}9.36 \\ 9.92\end{matrix} ) , {μ}_{2} := ( \begin{matrix}8.58 \\ 9.06\end{matrix} ) , \\ {Σ}_{1} := ( \begin{matrix}0.25 & - 0.32 \\ - 0.32 & 1.47\end{matrix} ) , {Σ}_{2} := ( \begin{matrix}0.22 & - 0.26 \\ - 0.26 & 0.87\end{matrix} )$$

iii) Another choice for genes, μ₁, μ₂, Σ₁, and Σ₂ is g₁: binary logarithm of raw expression value of 209374_s_at, g₂: binary logarithm of raw expression value of 206133_at, and

$${μ}_{1} := ( \begin{matrix}12.48 \\ 8.90\end{matrix} ) , {μ}_{2} := ( \begin{matrix}9.90 \\ 7.71\end{matrix} ) , \\ {Σ}_{1} := ( \begin{matrix}2.11 & - 0.075 \\ - 0.075 & 0.67\end{matrix} ) , {Σ}_{2} := ( \begin{matrix}2.97 & - 0.44 \\ - 0.44 & 0.40\end{matrix} )$$

For the separation of (ESR1− C) against (ESR1− D), the following partial classifier is used:
i) With g₁ being the mean of the binary logarithms of the absolute expression levels of 209392_at and 210839_s_at and g₂ being the mean of the binary logarithms of the absolute expression level of209135_at and 210896_s_at, evaluate

$$\begin{matrix} {p}_{1} := \frac{1}{\sqrt{{( 2 \cdot π )}^{2} \cdot \vert det {Σ}_{1} \vert}} \cdot exp ( - \frac{1}{2} \cdot {( g - {μ}_{1} )}^{t} {Σ}_{1}^{- 1} ( g - {μ}_{1} ) ) \\ {p}_{2} := \frac{1}{\sqrt{{( 2 \cdot π )}^{2} \cdot \vert det {Σ}_{2} \vert}} \cdot exp ( - \frac{1}{2} \cdot {( g - {μ}_{2} )}^{t} {Σ}_{2}^{- 1} ( g - {μ}_{2} ) ) \\ with \\ g := ( \begin{matrix}{g}_{1} \\ {g}_{2}\end{matrix} ) , {μ}_{1} := ( \begin{matrix}11.25 \\ 8.84\end{matrix} ) , {μ}_{2} := ( \begin{matrix}8.85 \\ 10.10\end{matrix} ) , \\ {Σ}_{1} := ( \begin{matrix}0.18 & 0.26 \\ 0.26 & 0.64\end{matrix} ) , {Σ}_{2} := ( \begin{matrix}0.97 & - 0.052 \\ - 0.052 & 0.85\end{matrix} )\end{matrix}$$

If p₁>p₂, we assign the unknown sample to the first cluster, ESR1− C, and if not, to the second cluster, ESR1− D.
ii) Another choice for genes, μ₁, μ₂, Σ₁, and Σ₂ is g₁: binary logarithm of raw expression value of 219777_at, g₂: binary logarithm of raw expression value of 213508_at, and

$${μ}_{1} := ( \begin{matrix}9.89 \\ 9.06\end{matrix} ) , {μ}_{2} := ( \begin{matrix}8.10 \\ 10.10\end{matrix} ) , \\ {Σ}_{1} := ( \begin{matrix}0.13 & 0.11 \\ 0.11 & 0.13\end{matrix} ) , {Σ}_{2} := ( \begin{matrix}1.03 & 0.065 \\ 0.065 & 0.75\end{matrix} )$$

iii) Another choice for genes, μ₁, μ₂, Σ₁ and Σ₂ is g₁: mean of binary logarithms of raw expression values of 218806_s_at and 218807_at, g₂: binary logarithm of raw expression value of 208370_s_at, and

$${μ}_{1} := ( \begin{matrix}8.03 \\ 10.00\end{matrix} ) , {μ}_{2} := ( \begin{matrix}9.47 \\ 9.20\end{matrix} ) , \\ {Σ}_{1} := ( \begin{matrix}0.13 & 0.15 \\ 0.15 & 0.23\end{matrix} ) , {Σ}_{2} := ( \begin{matrix}0.62 & 0.022 \\ 0.022 & 0.41\end{matrix} )$$

For the separation of (ESR1++, ESR1+ ER, ESR1+ EM) against (ESR1+ FHL+, ESR1+ FHL++, ESR1+ LM), the following partial classifier is used:
i) With g₁ being the binary logarithm of the absolute expression level of 208747_s_at and g₂ being the binary logarithm of the absolute expression level of 38158_at, evaluate

$${p}_{1} := \frac{1}{\sqrt{{( 2 - π )}^{2} - \vert {det Σ}_{1} \vert}} \cdot exp ( - \frac{1}{2} \cdot {( g - {μ}_{1} )}^{t} {Σ}_{1}^{- 1} ( g - {μ}_{1} ) )$$

$${p}_{2} := \frac{1}{\sqrt{{( 2 - π )}^{2} - \vert {det Σ}_{2} \vert}} \cdot exp ( - \frac{1}{2} \cdot {( g - {μ}_{2} )}^{t} {Σ}_{2}^{- 1} ( g - {μ}_{2} ) )$$

$$with$$

$$g := ( \begin{matrix}{g}_{1} \\ {g}_{2}\end{matrix} ) , \\ {μ}_{1} := ( \begin{matrix}10.82 \\ 8.28\end{matrix} ) , \\ {μ}_{2} := ( \begin{matrix}12.37 \\ 7.54\end{matrix} ) , \\ {Σ}_{1} := ( \begin{matrix}1.13 & - 0.10 \\ - 0.10 & 0.37\end{matrix} ) , \\ {Σ}_{2} := ( \begin{matrix}0.23 & 0.072 \\ 0.072 & 0.33\end{matrix} )$$

If p₁>p₂, we assign the unknown sample to the first group of clusters, ESR1++, ESR1+ ER, ESR1+ EM, and if not, to the second group of clusters, ESR1+ FHL+, ESR1+ FHL++, ESR1+ LM.
ii) Another choice for genes, μ₁, μ₂, Σ₁, and Σ₂ is g₁: binary logarithm of raw expression values of 216401_x_at, g₂: binary logarithm of raw expression values of 204222_s_at, and

$${μ}_{1} := ( \begin{matrix}6.27 \\ 7.41\end{matrix} ) , \\ {μ}_{2} := ( \begin{matrix}9.73 \\ 8.43\end{matrix} ) , \\ {Σ}_{1} := ( \begin{matrix}3.79 & 0.050 \\ 0.050 & 0.28\end{matrix} ) , \\ {Σ}_{2} := ( \begin{matrix}1.43 & 0.13 \\ 0.13 & 0.23\end{matrix} )$$

iii) Another choice for genes, μ₁, μ₂, Σ₁, and Σ₂ is g₁: binary logarithm of raw expression values of 214768_x_at, g₂: binary logarithm of raw expression values of 202238_s_at, and

$${μ}_{1} := ( \begin{matrix}7.88 \\ 9.73\end{matrix} ) , \\ {μ}_{2} := ( \begin{matrix}10.05 \\ 10.91\end{matrix} ) , \\ {Σ}_{1} := ( \begin{matrix}1.36 & - 0.15 \\ - 0.15 & 0.97\end{matrix} ) , \\ {Σ}_{2} := ( \begin{matrix}1.18 & - 0.14 \\ - 0.14 & 0.34\end{matrix} )$$

For the separation of (ESR1++) against (ESR1+ ER, ESR1+ EM), the following partial classifier is used:
i) With g₁ being the binary logarithm of the absolute expression level of 213288_at and g₂ being the binary logarithm of the absolute expression level of 204897_at, evaluate

$${p}_{1} := \frac{1}{\sqrt{{( 2 - π )}^{2} - \vert {det Σ}_{1} \vert}} \cdot exp ( - \frac{1}{2} \cdot {( g - {μ}_{1} )}^{t} {Σ}_{1}^{- 1} ( g - {μ}_{1} ) )$$

$${p}_{2} := \frac{1}{\sqrt{{( 2 - π )}^{2} - \vert {det Σ}_{2} \vert}} \cdot exp ( - \frac{1}{2} \cdot {( g - {μ}_{2} )}^{t} {Σ}_{2}^{- 1} ( g - {μ}_{2} ) )$$

$$with$$

$$g := ( \begin{matrix}{g}_{1} \\ {g}_{2}\end{matrix} ) , \\ {μ}_{1} := ( \begin{matrix}8.89 \\ 7.73\end{matrix} ) , \\ {μ}_{2} := ( \begin{matrix}9.24 \\ 8.51\end{matrix} ) , \\ {Σ}_{1} := ( \begin{matrix}0.15 & 0.025 \\ 0.025 & 0.32\end{matrix} ) , \\ {Σ}_{2} := ( \begin{matrix}0.85 & - 0.29 \\ - 0.29 & 0.49\end{matrix} )$$

If p₁>₂, we assign the unknown sample to the first cluster, ESR1++, and if not, to the second group of clusters, ESR1+ ER, ESR1+ EM.
ii) Another choice for genes, μ₁, μ₂, Σ₁, and Σ₂ is g₁: binary logarithm of raw expression value of 203868_s_at, g₂: mean of binary logarithms of raw expression values of 203438_at and 203439_s_at, and

$${μ}_{1} := ( \begin{matrix}7.70 \\ 11.04\end{matrix} ) , \\ {μ}_{2} := ( \begin{matrix}8.68 \\ 10.18\end{matrix} ) , \\ {Σ}_{1} := ( \begin{matrix}0.24 & 0.00063 \\ 0.00063 & 1.24\end{matrix} ) , \\ {Σ}_{2} := ( \begin{matrix}0.28 & 0.067 \\ 0.067 & 2.46\end{matrix} )$$

iii) Another choice for genes, μ₁, μ₂, Σ₁, and Σ₂ is g₁: binary logarithm of raw expression value of 209374_s_at, g₂: binary logarithm of raw expression value of 203895_at, and

$${μ}_{1} := ( \begin{matrix}7.47 \\ 6.55\end{matrix} ) , \\ {μ}_{2} := ( \begin{matrix}8.96 \\ 7.90\end{matrix} ) , \\ {Σ}_{1} := ( \begin{matrix}1.32 & 0.30 \\ 0.30 & 1.04\end{matrix} ) , \\ {Σ}_{2} := ( \begin{matrix}2.25 & - 0.46 \\ - 0.46 & 1.70\end{matrix} )$$

For the separation of (ESR1+ ER) against (ESR1+ EM), the following partial classifier is used:
i) With g₁ being the mean of the binary logarithms of the absolute expression level of 218468_s_at and 218469_at and g₂ being the mean of the binary logarithms of the absolute expression level of 203438_at and 203439_s_at, evaluate

$${p}_{1} := \frac{1}{\sqrt{{( 2 - π )}^{2} - \vert {det Σ}_{1} \vert}} \cdot exp ( - \frac{1}{2} \cdot {( g - {μ}_{1} )}^{t} {Σ}_{1}^{- 1} ( g - {μ}_{1} ) )$$

$${p}_{2} := \frac{1}{\sqrt{{( 2 - π )}^{2} - \vert {det Σ}_{2} \vert}} \cdot exp ( - \frac{1}{2} \cdot {( g - {μ}_{2} )}^{t} {Σ}_{2}^{- 1} ( g - {μ}_{2} ) )$$

$$with$$

$$g := ( \begin{matrix}{g}_{1} \\ {g}_{2}\end{matrix} ) , \\ {μ}_{1} := ( \begin{matrix}7.40 \\ 11.08\end{matrix} ) , \\ {μ}_{2} := ( \begin{matrix}8.66 \\ 9.06\end{matrix} ) , \\ {Σ}_{1} := ( \begin{matrix}1.24 & 0.41 \\ 0.41 & 1.73\end{matrix} ) , \\ {Σ}_{2} := ( \begin{matrix}0.77 & 0.48 \\ 0.48 & 1.09\end{matrix} )$$

If p₁>p₂, we assign the unknown sample to the first cluster, ESR1+ ER, and if not, to the second cluster, ESR1+ EM.
ii) Another choice for genes, μ₁, μ₂, Σ₁, and Σ₂ is g₁: mean of binary logarithms of raw expression values of 201656_at and 215177_s_at, g₂: binary logarithm of raw expression value of 201627_s_at, and

$${μ}_{1} := ( \begin{matrix}8.94 \\ 8.77\end{matrix} ) , \\ {μ}_{2} := ( \begin{matrix}8.17 \\ 9.78\end{matrix} ) , \\ {Σ}_{1} := ( \begin{matrix}0.32 & - 0.031 \\ - 0.031 & 0.38\end{matrix} ) , \\ {Σ}_{2} := ( \begin{matrix}0.66 & 0.14 \\ 0.14 & 0.76\end{matrix} )$$

iii) Another choice for genes, μ₁, μ₂, Σ₁, and Σ₂ is g₁: binary logarithm of raw expression value of 219197_s_at, g₂: binary logarithm of raw expression value of 209291_at, and

$${μ}_{1} := ( \begin{matrix}11.69 \\ 9.34\end{matrix} ) , \\ {μ}_{2} := ( \begin{matrix}9.76 \\ 7.75\end{matrix} ) , \\ {Σ}_{1} := ( \begin{matrix}1.69 & - 0.55 \\ - 0.55 & 2.12\end{matrix} ) , \\ {Σ}_{2} := ( \begin{matrix}1.60 & - 0.29 \\ - 0.29 & 1.02\end{matrix} )$$

For the separation of (ESR1+ FHL+, ESR1+ FHL++) against (ESR1+ LM), the following partial classifier is used:
i) With g₁ being the mean of the binary logarithms of the absolute expression level of 205479_s_at and 211668_s_at and g₂ being the binary logarithm of the absolute expression level of 203797_at, evaluate

$${p}_{1} := \frac{1}{\sqrt{{( 2 - π )}^{2} - \vert {det Σ}_{1} \vert}} \cdot exp ( - \frac{1}{2} \cdot {( g - {μ}_{1} )}^{t} {Σ}_{1}^{- 1} ( g - {μ}_{1} ) )$$

$${p}_{2} := \frac{1}{\sqrt{{( 2 - π )}^{2} - \vert {det Σ}_{2} \vert}} \cdot exp ( - \frac{1}{2} \cdot {( g - {μ}_{2} )}^{t} {Σ}_{2}^{- 1} ( g - {μ}_{2} ) )$$

$$with$$

$$g := ( \begin{matrix}{g}_{1} \\ {g}_{2}\end{matrix} ) , \\ {μ}_{1} := ( \begin{matrix}9.19 \\ 8.61\end{matrix} ) , \\ {μ}_{2} := ( \begin{matrix}10.01 \\ 8.08\end{matrix} ) , \\ {Σ}_{1} := ( \begin{matrix}0.38 & 0.11 \\ 0.11 & 0.28\end{matrix} ) , \\ {Σ}_{2} := ( \begin{matrix}0.62 & 0.25 \\ 0.25 & 0.22\end{matrix} )$$

If p₁>p₂, we assign the unknown sample to the first group of clusters, ESR1+ FHL+, ESR1+ FHL++, and if not, to the second cluster, ESR1+ LM.
ii) Another choice for genes, μ₁, μ₂, Σ₁, and Σ₂ is g₁: binary logarithm of raw expression value of 212935_at, g₂: binary logarithm of raw expression value of 212494_at, and

$${μ}_{1} := ( \begin{matrix}8.49 \\ 9.15\end{matrix} ) , \\ {μ}_{2} := ( \begin{matrix}9.30 \\ 8.59\end{matrix} ) , \\ {Σ}_{1} := ( \begin{matrix}0.92 & 0.11 \\ 0.11 & 0.29\end{matrix} ) , \\ {Σ}_{2} := ( \begin{matrix}1.04 & 0.31 \\ 0.31 & 0.097\end{matrix} )$$

iii) Another choice for genes, μ₁, μ₂, Σ₁, and Σ₂ is g₁: binary logarithm of raw expression value of 221530_s_at, g₂: binary logarithm of raw expression value of 202177_at, and

$${μ}_{1} := ( \begin{matrix}10.79 \\ 9.23\end{matrix} ) , \\ {μ}_{2} := ( \begin{matrix}10.13 \\ 8.55\end{matrix} ) , \\ {Σ}_{1} := ( \begin{matrix}0.25 & 0.026 \\ 0.026 & 0.23\end{matrix} ) , \\ {Σ}_{2} := ( \begin{matrix}0.081 & - 0.11 \\ - 0.11 & 0.19\end{matrix} )$$

For the separation of (ESR1+ FHL++) against (ESR1+ FHL+), the following partial classifier is used:
i) With g₁ being the binary logarithm of the absolute expression level of 209714_s_at and g₂ being the binary logarithm of the absolute expression level of 204259_at, evaluate

$${p}_{1} := \frac{1}{\sqrt{{( 2 - π )}^{2} - \vert {det Σ}_{1} \vert}} \cdot exp ( - \frac{1}{2} \cdot {( g - {μ}_{1} )}^{t} {Σ}_{1}^{- 1} ( g - {μ}_{1} ) )$$

$${p}_{2} := \frac{1}{\sqrt{{( 2 - π )}^{2} - \vert {det Σ}_{2} \vert}} \cdot exp ( - \frac{1}{2} \cdot {( g - {μ}_{2} )}^{t} {Σ}_{2}^{- 1} ( g - {μ}_{2} ) )$$

$$with$$

$$g := ( \begin{matrix}{g}_{1} \\ {g}_{2}\end{matrix} ) , \\ {μ}_{1} := ( \begin{matrix}7.48 \\ 10.03\end{matrix} ) , \\ {μ}_{2} := ( \begin{matrix}8.12 \\ 9.20\end{matrix} ) , \\ {Σ}_{1} := ( \begin{matrix}0.17 & - 0.074 \\ - 0.074 & 0.21\end{matrix} ) , \\ {Σ}_{2} := ( \begin{matrix}0.31 & 0.33 \\ 0.33 & 1.16\end{matrix} )$$

If p₁>p₂, we assign the unknown sample to the first cluster, ESR1+ FHL++, and if not, to the second cluster, ESR1+ FHL+.
ii) Another choice for genes, μ₁, μ₂, Σ₁, and Σ₂ is g₁: binary logarithm of raw expression value of 209200_at, g₂: binary logarithm of raw expression value of 204041_at, and

$${μ}_{1} := ( \begin{matrix}9.07 \\ 11.61\end{matrix} ) , \\ {μ}_{2} := ( \begin{matrix}8.52 \\ 10.20\end{matrix} ) , \\ {Σ}_{1} := ( \begin{matrix}0.24 & 0.18 \\ 0.18 & 0.34\end{matrix} ) , \\ {Σ}_{2} := ( \begin{matrix}0.19 & - 0.011 \\ - 0.101 & 2.29\end{matrix} )$$

iii) Another choice for genes, μ₁, μ₂, Σ₁, and Σ₂ is g₁: mean of binary logarithms of raw expression values of 202954_at, 208079_s_at, and 204092_s_at, g₂: binary logarithm of raw expression value of 218644_at, and

$${μ}_{1} := ( \begin{matrix}7.52 \\ 8.15\end{matrix} ) , \\ {μ}_{2} := ( \begin{matrix}8.24 \\ 8.34\end{matrix} ) , \\ {Σ}_{1} := ( \begin{matrix}0.16 & - 0.049 \\ - 0.049 & 0.073\end{matrix} ) , \\ {Σ}_{2} := ( \begin{matrix}0.25 & - 0.099 \\ - 0.099 & 0.31\end{matrix} )$$

2. Classification of an unknown sample is done by measuring the gene expression levels of some or all of the genes used in the partial classifiers (including an estrogen receptor related gene), determining the estrogen receptor state and then using one or more partial classifiers to subsequently assign the given unknown probe to one or more class or groups of classes using the partial classifiers obtained on a training set in step 1.

It is to be understood that alternative marker genes can be used for classification according to the present invention, in particular if said alternative marker genes show a similar expression pattern as show those used in the examples above. Alternative marker genes useful in methods and systems of the invention are listed in Tables 1-8 below.

TABLE 1
Genes useful for separation of ESR1-A, ESR1-B <-> ESR1-C, ESR1-D

| Affymetrix | GenBank | | |
|---|---|---|---|
| Probe Set ID | Accession | | |
| HG U133A | No | Gene Symbol | Unigene ID |
| 55616_at | AI703342 | CAB2 | Hs.91668 |
| 51158_at | AI801973 | — | Hs.27373 |
| 32094_at | AB017915 | CHST3 | Hs.158304 |
| 222258_s_at | AF015043.1 | SH3BP4 | Hs.17667 |
| 222039_at | AA292789 | LOC146909 | Hs.433234 |
| 221922_at | AW195581 | LGN | Hs.278338 |
| 221880_s_at | AI279819 | — | Hs.27373 |
| 221811_at | BF033007 | CAB2 | Hs.91668 |
| 221521_s_at | BC003186.1 | LOC51659 | Hs.433180 |
| 221505_at | AW612574 | LANPL | Hs.71331 |
| 221436_s_at | NM_031299 | GRCC8 | Hs.30114 |
| 221185_s_at | NM_025111 | DKFZp434B227 | Hs.334483 |
| 221024_s_at | NM_030777 | SLC2A10 | Hs.305971 |
| 220651_s_at | NM_018518 | MCM10 | Hs.198363 |
| 220625_s_at | AF115403.1 | ELF5 | Hs.11713 |
| 220559_at | NM_001426 | EN1 | Hs.271977 |
| 220425_x_at | NM_017578 | ROPN1 | Hs.194093 |
| 220192_x_at | NM_012391 | PDEF | Hs.79414 |
| 219959_at | NM_017947 | HMCS | Hs.157986 |
| 219918_s_at | NM_018123 | ASPM | Hs.121028 |
| 219768_at | NM_024626 | FLJ22418 | Hs.36563 |
| 219735_s_at | NM_014553 | LBP-9 | Hs.114747 |
| 219582_at | NM_024576 | FLJ21079 | Hs.16512 |
| 219572_at | NM_017954 | FLJ20761 | Hs.107872 |
| 219498_s_at | NM_018014 | BCL11A | Hs.130881 |
| 219497_s_at | NM_022893 | BCL11A | Hs.130881 |
| 219157_at | NM_007246 | KLHL2 | Hs.122967 |
| 219148_at | NM_018492 | TOPK | Hs.104741 |
| 218918_at | NM_020379 | MAN1C1 | Hs.8910 |
| 218870_at | NM_018460 | ARHGAP15 | Hs.177812 |
| 218807_at | NM_006113 | VAV3 | Hs.267659 |
| 218806_s_at | AF118887.1 | VAV3 | Hs.267659 |
| 218782_s_at | NM_014109 | PRO2000 | Hs.222088 |
| 218726_at | NM_018410 | DKFZp762E1312 | Hs.104859 |
| 218665_at | NM_012193 | FZD4 | Hs.19545 |
| 218542_at | NM_018131 | C10orf3 | Hs.14559 |
| 218502_s_at | NM_014112 | TRPS1 | Hs.26102 |
| 218353_at | | RGS5 | Hs.274368 |
| 218331_s_at | NM_017782 | FLJ20360 | Hs.26434 |
| 218298_s_at | NM_024952 | FLJ20950 | Hs.285673 |
| 218211_s_at | NM_024101 | MLPH | Hs.297405 |
| 218009_s_at | NM_003981 | PRC1 | Hs.344037 |
| 217989_at | NM_016245 | RetSDR2 | Hs.12150 |
| 217901_at | BF031829 | — | Hs.348710 |
| 216836_s_at | X03363.1 | ERBB2 | Hs.323910 |
| 216092_s_at | AL365347.1 | SLC7A8 | Hs.22891 |
| 215945_s_at | BC005016.1 | TRIM2 | Hs.12372 |
| 215726_s_at | M22976.1 | CYB5 | Hs.83834 |
| 215034_s_at | AI189753 | TM4SF1 | Hs.409060 |
| 214667_s_at | AK026607.1 | PIG11 | Hs.433813 |
| 214404_x_at | AI307915 | PDEF | Hs.79414 |
| 213441_x_at | AI745526 | PDEF | Hs.79414 |
| 213260_at | AU145890 | — | Hs.284186 |
| 213226_at | AI346350 | PMSCL1 | Hs.91728 |
| 213122_at | AI096375 | KIAA1750 | Hs.173094 |
| 213060_s_at | U58515.1 | CHI3L2 | Hs.154138 |
| 212771_at | AU150943 | LOC221061 | Hs.66762 |
| 212730_at | AK026420.1 | DMN | Hs.10587 |
| 212708_at | AV721987 | — | Hs.184779 |
| 212594_at | N92498 | — | Hs.326248 |
| 212510_at | AA135522 | KIAA0089 | Hs.82432 |
| 212458_at | AW138902 | LOC200734 | Hs.173108 |
| 212256_at | BE906572 | GALNT10 | Hs.107260 |
| 211709_s_at | BC005810.1 | SCGF | Hs.425339 |
| 211657_at | M18728.1 | CEACAM6 | Hs.73848 |
| 210933_s_at | BC004908.1 | MGC4655 | Hs.381638 |
| 210761_s_at | AB008790.1 | GRB7 | Hs.86859 |
| 210605_s_at | BC003610.1 | MFGE8 | Hs.3745 |
| 210559_s_at | D88357.1 | CDC2 | Hs.334562 |
| 209897_s_at | AF055585.1 | SLIT2 | Hs.29802 |
| 209842_at | AI367319 | SOX10 | Hs.44317 |
| 209747_at | J03241.1 | TGFB3 | Hs.2025 |
| 209504_s_at | AF081583.1 | PLEKHB1 | Hs.380812 |
| 209396_s_at | M80927.1 | CHI3L1 | Hs.75184 |
| 209395_at | M80927.1 | CHI3L1 | Hs.75184 |
| 209387_s_at | M90657.1 | TM4SF1 | Hs.351316 |
| 209366_x_at | M22865.1 | CYB5 | Hs.83834 |
| 209173_at | AF088867.1 | AGR2 | Hs.91011 |
| 209071_s_at | AF159570.1 | RGS5 | Hs.24950 |
| 209070_s_at | AI183997 | RGS5 | Hs.24950 |
| 208998_at | U94592.1 | UCP2 | Hs.80658 |
| 208190_s_at | NM_015925 | LISCH7 | Hs.95697 |
| 208103_s_at | NM_030920 | LANPL | Hs.71331 |
| 208072_s_at | NM_003648 | DGKD | Hs.115907 |
| 208009_s_at | NM_014448 | ARHGEF16 | Hs.87435 |
| 207843_x_at | NM_001914 | CYB5 | Hs.83834 |
| 207828_s_at | NM_005196 | CENPF | Hs.77204 |
| 207357_s_at | NM_017540 | GALNT10 | Hs.107260 |
| 206560_s_at | NM_006533 | MIA | Hs.279651 |
| 205453_at | NM_002145 | HOXB2 | Hs.2733 |
| 205405_at | NM_003966 | SEMA5A | Hs.27621 |
| 205240_at | NM_013296 | LGN | Hs.278338 |
| 205044_at | NM_014211 | GABRP | Hs.70725 |
| 204855_at | NM_002639 | SERPINB5 | Hs.55279 |
| 204825_at | NM_014791 | MELK | Hs.184339 |
| 204822_at | NM_003318 | TTK | Hs.169840 |
| 204751_x_at | NM_004949 | DSC2 | Hs.239727 |
| 204641_at | NM_002497 | NEK2 | Hs.153704 |
| 204613_at | NM_002661 | PLCG2 | Hs.75648 |
| 204288_s_at | NM_021069 | ARGBP2 | Hs.379795 |
| 204285_s_at | AI857639 | PMAIP1 | Hs.96 |
| 204259_at | NM_002423 | MMP7 | Hs.2256 |
| 204153_s_at | NM_002405 | MFNG | Hs.31939 |
| 204146_at | BE966146 | PIR51 | Hs.24596 |
| 204030_s_at | NM_014575 | SCHIP1 | Hs.61490 |
| 204015_s_at | BC002671.1 | DUSP4 | Hs.2359 |
| 203764_at | NM_014750 | DLG7 | Hs.77695 |
| 203706_s_at | NM_003507 | FZD7 | Hs.173859 |
| 203705_s_at | AI333651 | FZD7 | Hs.173859 |
| 203693_s_at | NM_001949 | E2F3 | Hs.1189 |
| 203592_s_at | NM_005860 | FSTL3 | Hs.433827 |
| 203570_at | NM_005576 | LOXL1 | Hs.65436 |
| 203362_s_at | NM_002358 | MAD2L1 | Hs.79078 |
| 203358_s_at | NM_004456 | EZH2 | Hs.77256 |
| 203343_at | NM_003359 | UGDH | Hs.28309 |
| 203214_x_at | NM_001786 | CDC2 | Hs.334562 |
| 203213_at | AL524035 | CDC2 | Hs.334562 |
| 202996_at | NM_021173 | POLD4 | Hs.82520 |
| 202991_at | NM_006804 | STARD3 | Hs.77628 |
| 202948_at | NM_000877 | IL1R1 | Hs.82112 |
| 202870_s_at | NM_001255 | CDC20 | Hs.82906 |
| 202752_x_at | NM_012244 | SLC7A8 | Hs.22891 |
| 202747_s_at | NM_004867 | ITM2A | Hs.17109 |
| 202746_at | AL021786 | ITM2A | Hs.17109 |
| 202589_at | NM_001071 | TYMS | Hs.29475 |
| 202580_x_at | NM_021953 | FOXM1 | Hs.239 |
| 202412_s_at | AW499935 | USP1 | Hs.35086 |
| 202345_s_at | NM_001444 | FABP5 | Hs.153179 |
| 202342_s_at | NM_015271 | TRIM2 | Hs.12372 |
| 202236_s_at | NM_003051 | SLC16A1 | Hs.75231 |
| 202037_s_at | NM_003012 | SFRP1 | Hs.7306 |
| 202036_s_at | AF017987.1 | SFRP1 | Hs.7306 |
| 202035_s_at | AI332407 | SFRP1 | Hs.7306 |
| 201819_at | NM_005505 | SCARB1 | Hs.180616 |
| 201564_s_at | NM_003088 | FSCN1 | Hs.118400 |
| 201292_at | NM_001067.1 | TOP2A | Hs.156346 |
| 201291_s_at | NM_001067.1 | TOP2A | Hs.156346 |
| 201117_s_at | NM_001873 | CPE | Hs.75360 |
| 201116_s_at | AI922855 | CPE | Hs.75360 |
| 200824_at | NM_000852 | GSTP1 | Hs.226795 |
| 200783_s_at | NM_005563 | STMN1 | Hs.406269 |

TABLE 2
Genes useful for separation of ESR1-A <-> ESR1-B

| Affymetrix | GenBank | | |
|---|---|---|---|
| Probe Set ID HG | Accession | | |
| U133A | No | Gene Symbol | Unigene ID |
| 38149_at | D29642 | KIAA0053 | Hs.1528 |
| 34210_at | N90866 | CDW52 | Hs.276770 |
| 219812_at | NM_024070 | MGC2463 | Hs.323634 |
| 219716_at | NM_030641 | APOL6 | Hs.257352 |
| 219630_at | NM_005764 | DD96 | Hs.271473 |
| 219243_at | NM_018326 | HIMAP4 | Hs.30822 |
| 219157_at | NM_007246 | KLHL2 | Hs.122967 |
| 217236_x_at | S74639.1 | IGHM | Hs.153261 |
| 215603_x_at | AI344075 | GGT2 | Hs.289098 |
| 215189_at | X99142.1 | KRTHB6 | Hs.278658 |
| 214916_x_at | BG340548 | IGHM | Hs.153261 |
| 214777_at | BG482805 | IGKC | Hs.406565 |
| 214765_s_at | AK024677.1 | ASAHL | Hs.264330 |
| 214620_x_at | BF038548 | PAM | Hs.83920 |
| 214617_at | AI445650 | PRF1 | Hs.411106 |
| 214433_s_at | NM_003944.1 | SELENBP1 | Hs.334841 |
| 214339_s_at | AA744529 | MAP4K1 | Hs.95424 |
| 214239_x_at | AI560455 | LOC284106 | Hs.184669 |
| 213958_at | AW134823 | CD6 | Hs.81226 |
| 213603_s_at | BE138888 | RAC2 | Hs.367740 |
| 213551_x_at | AI744229 | LOC284106 | Hs.184669 |
| 213539_at | NM_000732.1 | CD3D | Hs.95327 |
| 213193_x_at | AL559122 | TRB@ | Hs.303157 |
| 213036_x_at | Y15724 | ATP2A3 | Hs.5541 |
| 213004_at | AF007150.1 | ANGPTL2 | Hs.8025 |
| 213001_at | AF007150.1 | ANGPTL2 | Hs.8025 |
| 212914_at | AV648364 | CBX7 | Hs.356416 |
| 212588_at | AI809341 | PTPRC | Hs.170121 |
| 212587_s_at | AI809341 | PTPRC | Hs.170121 |
| 212538_at | AL576253 | zizimini 1 | Hs.8021 |
| 212415_at | D50918.1 | 6-Sep | Hs.90998 |
| 212314_at | AB018289.1 | KIAA0746 | Hs.49500 |
| 212311_at | AB018289.1 | KIAA0746 | Hs.49500 |
| 212233_at | AL523076 | — | Hs.82503 |
| 211998_at | NM_005324.1 | H3F3B | Hs.180877 |
| 211902_x_at | L34703.1 | TRA@ | Hs.74647 |
| 211796_s_at | AF043179.1 | TRB@ | Hs.303157 |
| 211795_s_at | AF198052.1 | FYB | Hs.58435 |
| 211742_s_at | BC005926.1 | EVI2B | Hs.5509 |
| 211639_x_at | L23518.1 | IGHM | Hs.153261 |
| 211417_x_at | L20493.1 | — | Hs.352120 |
| 211339_s_at | D13720.1 | ITK | Hs.211576 |
| 211277_x_at | BC004369.1 | APP | Hs.177486 |
| 211138_s_at | BC005297.1 | KMO | Hs.107318 |
| 210972_x_at | M15565.1 | TRA@ | Hs.74647 |
| 210915_x_at | M15564.1 | TRB@ | Hs.303157 |
| 210629_x_at | AF000425.1 | LST1 | Hs.380427 |
| 210140_at | AF031824.1 | CST7 | Hs.143212 |
| 210031_at | J04132.1 | CD3Z | Hs.97087 |
| 210029_at | M34455.1 | INDO | Hs.840 |
| 209919_x_at | L20490.1 | GGTL4 | Hs.352119 |
| 209879_at | AI741056 | SELPLG | Hs.79283 |
| 209846_s_at | BC002832.1 | BTN3A2 | Hs.87497 |
| 209827_s_at | NM_004513.1 | IL16 | Hs.82127 |
| 209671_x_at | M12423.1 | TRA@ | Hs.74647 |
| 209670_at | M12959.1 | TRA@ | Hs.74647 |
| 209606_at | L06633.1 | PSCDBP | Hs.270 |
| 209499_x_at | BF448647 | TNFSF13 | Hs.54673 |
| 209374_s_at | BC001872.1 | IGHM | Hs.153261 |
| 209355_s_at | AB000889.1 | PPAP2B | Hs.432840 |
| 209351_at | BC002690.1 | KRT14 | Hs.355214 |
| 209205_s_at | BC003600.1 | LMO4 | Hs.3844 |
| 209083_at | U34690.1 | CORO1A | Hs.109606 |
| 208284_x_at | NM_013421 | GGT1 | Hs.401847 |
| 208078_s_at | NM_030751 | TCF8 | Hs.232068 |
| 207238_s_at | NM_002838 | PTPRC | Hs.170121 |
| 207131_x_at | NM_013430 | GGT1 | Hs.401847 |
| 206978_at | NM_000647 | CCR2 | Hs.395 |
| 206666_at | NM_002104 | GZMK | Hs.3066 |
| 206227_at | NM_003613 | CILP | Hs.151407 |
| 206150_at | NM_001242 | TNFRSF7 | Hs.355307 |
| 206133_at | NM_017523 | HSXIAPAF1 | Hs.139262 |
| 206118_at | NM_003151 | STAT4 | Hs.80642 |
| 206082_at | NM_006674 | P5-1 | Hs.1845 |
| 205977_s_at | NM_005232 | EPHA1 | Hs.89839 |
| 205965_at | NM_006399 | BATF | Hs.41691 |
| 205890_s_at | NM_006398 | UBD | Hs.44532 |
| 205842_s_at | AF001362.1 | JAK2 | Hs.115541 |
| 205831_at | NM_001767 | CD2 | Hs.89476 |
| 205821_at | NM_007360 | D12S2489E | Hs.74085 |
| 205798_at | NM_002185 | IL7R | Hs.362807 |
| 205692_s_at | NM_001775 | CD38 | Hs.66052 |
| 205569_at | NM_014398 | LAMP3 | Hs.10887 |
| 205456_at | NM_000733 | CD3E | Hs.3003 |
| 205306_x_at | AI074145 | KMO | Hs.107318 |
| 205120_s_at | U29586.1 | SGCB | Hs.77501 |
| 205060_at | NM_003631 | PARG | Hs.91390 |
| 204951_at | NM_004310 | ARHH | Hs.109918 |
| 204949_at | NM_002162 | ICAM3 | Hs.99995 |
| 204912_at | NM_001558 | IL10RA | Hs.327 |
| 204891_s_at | NM_005356 | LCK | Hs.1765 |
| 204855_at | NM_002639 | SERPINB5 | Hs.55279 |
| 204834_at | NM_006682 | FGL2 | Hs.351808 |
| 204774_at | NM_014210 | EVI2A | Hs.70499 |
| 204677_at | NM_001795 | CDH5 | Hs.76206 |
| 204661_at | NM_001803 | CDW52 | Hs.276770 |
| 204655_at | NM_002985 | CCL5 | Hs.241392 |
| 204638_at | NM_001611 | ACP5 | Hs.1211 |
| 204613_at | NM_002661 | PLCG2 | Hs.75648 |
| 204502_at | NM_015474 | SAMHD1 | Hs.23889 |
| 204416_x_at | NM_001645 | APOC1 | Hs.268571 |
| 204279_at | NM_002800 | PSMB9 | Hs.381081 |
| 204205_at | NM_021822 | APOBEC3G | Hs.250619 |
| 204192_at | NM_001774 | CD37 | Hs.153053 |
| 204141_at | NM_001069 | TUBB | Hs.336780 |
| 204118_at | NM_001778 | CD48 | Hs.901 |
| 204116_at | NM_000206 | IL2RG | Hs.84 |
| 203960_s_at | NM_016126 | LOC51668 | Hs.46967 |
| 203951_at | NM_001299 | CNN1 | Hs.21223 |
| 203923_s_at | NM_000397 | CYBB | Hs.88974 |
| 203853_s_at | NM_012296 | GAB2 | Hs.30687 |
| 203793_x_at | NM_007144 | ZNF144 | Hs.184669 |
| 203760_s_at | U44403.1 | SLA | Hs.75367 |
| 203233_at | NM_000418 | IL4R | Hs.75545 |
| 203052_at | NM_000063 | C2 | Hs.2253 |
| 202957_at | NM_005335 | HCLS1 | Hs.14601 |
| 202902_s_at | NM_004079 | CTSS | Hs.181301 |
| 202664_at | AI005043 | — | Hs.24143 |
| 202575_at | NM_001878 | CRABP2 | Hs.183650 |
| 202528_at | NM_000403 | GALE | Hs.76057 |
| 202409_at | X07868 | — | Hs.251664 |
| 202307_s_at | NM_000593 | TAP1 | Hs.180062 |
| 202273_at | NM_002609 | PDGFRB | Hs.76144 |
| 202240_at | NM_005030 | PLK | Hs.433619 |
| 202147_s_at | NM_001550 | IFRD1 | Hs.7879 |
| 202146_at | AA747426 | IFRD1 | Hs.7879 |
| 201858_s_at | J03223.1 | PRG1 | Hs.1908 |
| 201694_s_at | NM_001964 | EGR1 | Hs.326035 |
| 201693_s_at | AV733950 | EGR1 | Hs.326035 |
| 201497_x_at | NM_022844 | MYH11 | Hs.78344 |
| 201450_s_at | NM_022037 | TIA1 | Hs.239489 |
| 201313_at | NM_001975 | ENO2 | Hs.146580 |
| 200824_at | NM_000852 | GSTP1 | Hs.226795 |
| 200632_s_at | NM_006096 | NDRG1 | Hs.75789 |
| 1405_i_at | M21121 | CCL5 | Hs.241392 |

TABLE 3
Genes useful for separation of ESR1-C <-> ESR1-D

| Affymetrix | | | |
|---|---|---|---|
| Probe Set ID | GenBank | | |
| HG U133A | Accession No | Gene Symbol | Unigene ID |
| 58780_s_at | R42449 | FLJ10357 | Hs.22451 |
| 55616_at | AI703342 | CAB2 | Hs.91668 |
| 38149_at | D29642 | KIAA0053 | Hs.1528 |
| 37117_at | Z83838 | ARHGAP8 | Hs.102336 |
| 34210_at | N90866 | CDW52 | Hs.276770 |
| 221811_at | BF033007 | CAB2 | Hs.91668 |
| 221601_s_at | AI084226 | TOSO | Hs.58831 |
| 220625_s_at | AF115403.1 | ELF5 | Hs.11713 |
| 220425_x_at | NM_017578 | ROPN1 | Hs.194093 |
| 220326_s_at | NM_018071 | FLJ10357 | Hs.22451 |
| 220192_x_at | NM_012391 | PDEF | Hs.79414 |
| 219812_at | NM_024070 | MGC2463 | Hs.323634 |
| 219777_at | NM_024711 | hIAN2 | Hs.105468 |
| 219471_at | NM_025113 | C13orf18 | Hs.288708 |
| 219411_at | NM_024712 | ELMO3 | Hs.105861 |
| 219395_at | NM_024939 | FLJ21918 | Hs.282093 |
| 219388_at | NM_024915 | FLJ13782 | Hs.257924 |
| 219304_s_at | NM_025208 | SCDGF-B | Hs.112885 |
| 219143_s_at | NM_017793 | FLJ20374 | Hs.8562 |
| 219127_at | NM_024320 | MGC11242 | Hs.36529 |
| 219010_at | NM_018265 | FLJ10901 | Hs.73239 |
| 218959_at | NM_017409 | HOXC10 | Hs.44276 |
| 218913_s_at | NM_016573 | GMIP | Hs.49427 |
| 218856_at | NM_016629 | TNFRSF21 | Hs.159651 |
| 218816_at | NM_018214 | LANO | Hs.35091 |
| 218807_at | NM_006113 | VAV3 | Hs.267659 |
| 218806_s_at | AF118887.1 | VAV3 | Hs.267659 |
| 218805_at | NM_018384 | IAN4L1 | Hs.26194 |
| 218678_at | NM_024609 | FLJ21841 | Hs.29076 |
| 218507_at | NM_013332 | HIG2 | Hs.61762 |
| 218380_at | NM_021730 | PP1044 | Hs.7212 |
| 218211_s_at | NM_024101 | MLPH | Hs.297405 |
| 218186_at | NM_020387 | RAB25 | Hs.150826 |
| 218180_s_at | NM_022772 | EPS8R2 | Hs.55016 |
| 218145_at | NM_021158 | C20orf97 | Hs.26802 |
| 217904_s_at | NM_012104 | BACE | Hs.49349 |
| 217767_at | NM_000064 | C3 | Hs.284394 |
| 217236_x_at | S74639.1 | IGHM | Hs.153261 |
| 216836_s_at | X03363.1 | ERBB2 | Hs.323910 |
| 216381_x_at | AL035413 | AKR7A3 | Hs.284236 |
| 216033_s_at | S74774.1 | FYN | Hs.169370 |
| 215785_s_at | AL161999.1 | CYFIP2 | Hs.258503 |
| 215726_s_at | M22976.1 | CYB5 | Hs.83834 |
| 215471_s_at | AJ242502.1 | MAP7 | Hs.146388 |
| 214617_at | AI445650 | PRF1 | Hs.411106 |
| 214581_x_at | BE568134 | TNFRSF21 | Hs.159651 |
| 214505_s_at | AF220153.1 | FHL1 | Hs.239069 |
| 214439_x_at | AF043899.1 | BIN1 | Hs.193163 |
| 214404_x_at | AI307915 | PDEF | Hs.79414 |
| 214175_x_at | BE043700 | RIL | Hs.424312 |
| 214038_at | AI984980 | CCL8 | Hs.271387 |
| 213620_s_at | AA126728 | ICAM2 | Hs.433303 |
| 213603_s_at | BE138888 | RAC2 | Hs.367740 |
| 213539_at | NM_000732.1 | CD3D | Hs.95327 |
| 213508_at | AA142942 | — | Hs.356665 |
| 213457_at | BF739959 | — | Hs.379414 |
| 213441_x_at | AI745526 | PDEF | Hs.79414 |
| 213375_s_at | N80918 | CG018 | Hs.22174 |
| 213338_at | BF062629 | RIS1 | Hs.35861 |
| 213193_x_at | AL559122 | TRB@ | Hs.303157 |
| 213160_at | D86964.1 | DOCK2 | Hs.17211 |
| 213005_s_at | D79994.1 | KANK | Hs.77546 |
| 212827_at | X17115.1 | IGHM | Hs.153261 |
| 212728_at | AB033058.1 | DLG3 | Hs.11101 |
| 212589_at | BG168858 | RRAS2 | Hs.206097 |
| 212588_at | AI809341 | PTPRC | Hs.170121 |
| 212587_s_at | AI809341 | PTPRC | Hs.170121 |
| 212458_at | AW138902 | LOC200734 | Hs.173108 |
| 212382_at | AK021980.1 | — | Hs.289068 |
| 212187_x_at | NM_000954.1 | PTGDS | Hs.8272 |
| 211796_s_at | AF043179.1 | TRB@ | Hs.303157 |
| 211795_s_at | AF198052.1 | FYB | Hs.58435 |
| 211748_x_at | BC005939.1 | PTGDS | Hs.8272 |
| 211742_s_at | BC005926.1 | EVI2B | Hs.5509 |
| 211663_x_at | M61900.1 | PTGDS | Hs.8272 |
| 211564_s_at | BC003096.1 | RIL | Hs.424312 |
| 211527_x_at | M27281.1 | VEGF | Hs.73793 |
| 211339_s_at | D13720.1 | ITK | Hs.211576 |
| 211071_s_at | BC006471.1 | AF1Q | Hs.75823 |
| 211056_s_at | BC006373.1 | SRD5A1 | Hs.552 |
| 210959_s_at | AF113128.1 | SRD5A1 | Hs.552 |
| 210915_x_at | M15564.1 | TRB@ | Hs.303157 |
| 210896_s_at | AF306765.1 | ASPH | Hs.283664 |
| 210839_s_at | D45421.1 | ENPP2 | Hs.174185 |
| 210761_s_at | AB008790.1 | GRB7 | Hs.86859 |
| 210547_x_at | L21181.1 | ICA1 | Hs.167927 |
| 210513_s_at | AF091352.1 | VEGF | Hs.73793 |
| 210399_x_at | U27336.1 | FUT6 | Hs.32956 |
| 210356_x_at | BC002807.1 | MS4A1 | Hs.89751 |
| 210347_s_at | AF080216.1 | BCL11A | Hs.130881 |
| 210298_x_at | AF098518.1 | FHL1 | Hs.239069 |
| 209842_at | AI367319 | SOX10 | Hs.44317 |
| 209687_at | U19495.1 | CXCL12 | Hs.385710 |
| 209670_at | M12959.1 | TRA@ | Hs.74647 |
| 209633_at | L07590.1 | PPP2R3A | Hs.28219 |
| 209606_at | L06633.1 | PSCDBP | Hs.270 |
| 209584_x_at | AF165520.1 | APOBEC3C | Hs.8583 |
| 209583_s_at | AF063591.1 | MOX2 | Hs.79015 |
| 209522_s_at | BC000723.1 | CRAT | Hs.12068 |
| 209496_at | BC000069.1 | RARRES2 | Hs.37682 |
| 209392_at | L35594.1 | ENPP2 | Hs.174185 |
| 209366_x_at | M22865.1 | CYB5 | Hs.83834 |
| 209343_at | BC002449.1 | FLJ13612 | Hs.24391 |
| 209337_at | AF063020.1 | PSIP2 | Hs.82110 |
| 209293_x_at | U16153.1 | ID4 | Hs.34853 |
| 209291_at | NM_001546.1 | ID4 | Hs.34853 |
| 209213_at | BC002511.1 | CBR1 | Hs.88778 |
| 209200_at | N22468 | MEF2C | Hs.78995 |
| 209199_s_at | N22468 | MEF2C | Hs.78995 |
| 209135_at | AF289489.1 | ASPH | Hs.283664 |
| 209083_at | U34690.1 | CORO1A | Hs.109606 |
| 209016_s_at | BC002700.1 | KRT7 | Hs.23881 |
| 209008_x_at | U76549.1 | KRT8 | Hs.242463 |
| 208983_s_at | M37780.1 | PECAM1 | Hs.78146 |
| 208881_x_at | BC005247.1 | IDI1 | Hs.76038 |
| 208370_s_at | NM_004414 | DSCR1 | Hs.184222 |
| 208083_s_at | NM_000888 | ITGB6 | Hs.57664 |
| 207843_x_at | NM_001914 | CYB5 | Hs.83834 |
| 207842_s_at | NM_007359 | MLN51 | Hs.83422 |
| 207808_s_at | NM_000313 | PROS1 | Hs.64016 |
| 207540_s_at | NM_003177 | SYK | Hs.74101 |
| 207339_s_at | NM_002341 | LTB | Hs.890 |
| 207238_s_at | NM_002838 | PTPRC | Hs.170121 |
| 206666_at | NM_002104 | GZMK | Hs.3066 |
| 206560_s_at | NM_006533 | MIA | Hs.279651 |
| 206481_s_at | NM_001290 | LDB2 | Hs.4980 |
| 206469_x_at | NM_012067 | AKR7A3 | Hs.284236 |
| 206364_at | NM_014875 | KIF14 | Hs.3104 |
| 206303_s_at | AF191653.1 | NUDT4 | Hs.355399 |
| 206150_at | NM_001242 | TNFRSF7 | Hs.355307 |
| 205980_s_at | NM_015366 | ARHGAP8 | Hs.102336 |
| 205968_at | NM_002252 | KCNS3 | Hs.47584 |
| 205961_s_at | NM_004682 | PSIP2 | Hs.82110 |
| 205926_at | NM_004843 | WSX1 | Hs.132781 |
| 205831_at | NM_001767 | CD2 | Hs.89476 |
| 205821_at | NM_007360 | D12S2489E | Hs.74085 |
| 205798_at | NM_002185 | IL7R | Hs.362807 |
| 205455_at | NM_002447 | MST1R | Hs.2942 |
| 205405_at | NM_003966 | SEMA5A | Hs.27621 |
| 205267_at | NM_006235 | POU2AF1 | Hs.2407 |
| 205079_s_at | NM_003829 | MPDZ | Hs.169378 |
| 205049_s_at | NM_001783 | CD79A | Hs.79630 |
| 205044_at | NM_014211 | GABRP | Hs.70725 |
| 205024_s_at | NM_002875 | RAD51 | Hs.343807 |
| 204951_at | NM_004310 | ARHH | Hs.109918 |
| 204949_at | NM_002162 | ICAM3 | Hs.99995 |
| 204942_s_at | NM_000695 | ALDH3B2 | Hs.87539 |
| 204912_at | NM_001558 | IL10RA | Hs.327 |
| 204784_s_at | NM_022443 | MLF1 | Hs.85195 |
| 204731_at | NM_003243 | TGFBR3 | Hs.342874 |
| 204683_at | NM_000873 | ICAM2 | Hs.433303 |
| 204679_at | NM_002245 | KCNK1 | Hs.79351 |
| 204678_s_at | U90065.1 | KCNK1 | Hs.79351 |
| 204675_at | NM_001047 | SRD5A1 | Hs.552 |
| 204661_at | NM_001803 | CDW52 | Hs.276770 |
| 204615_x_at | NM_004508 | IDI1 | Hs.76038 |
| 204613_at | NM_002661 | PLCG2 | Hs.75648 |
| 204563_at | NM_000655 | SELL | Hs.82848 |
| 204562_at | NM_002460 | IRF4 | Hs.82132 |
| 204446_s_at | NM_000698 | ALOX5 | Hs.89499 |
| 204442_x_at | NM_003573 | LTBP4 | Hs.85087 |
| 204396_s_at | NM_005308 | GPRK5 | Hs.211569 |
| 204345_at | NM_001856 | COL16A1 | Hs.26208 |
| 204220_at | NM_004877 | GMFG | Hs.5210 |
| 204198_s_at | AA541630 | RUNX3 | Hs.170019 |
| 204197_s_at | NM_004350 | RUNX3 | Hs.170019 |
| 204192_at | NM_001774 | CD37 | Hs.153053 |
| 204153_s_at | NM_002405 | MFNG | Hs.31939 |
| 204118_at | NM_001778 | CD48 | Hs.901 |
| 204116_at | NM_000206 | IL2RG | Hs.84 |
| 204099_at | NM_003078 | SMARCD3 | Hs.71622 |
| 204083_s_at | NM_003289 | TPM2 | Hs.300772 |
| 204061_at | NM_005044 | PRKX | Hs.147996 |
| 203936_s_at | NM_004994 | MMP9 | Hs.151738 |
| 203921_at | NM_004267 | CHST2 | Hs.8786 |
| 203911_at | NM_002885 | RAP1GA1 | Hs.433797 |
| 203685_at | NM_000633 | BCL2 | Hs.79241 |
| 203666_at | NM_000609 | CXCL12 | Hs.237356 |
| 203549_s_at | NM_000237 | LPL | Hs.180878 |
| 203548_s_at | BF672975 | LPL | Hs.180878 |
| 203281_s_at | NM_003335 | UBE1L | Hs.16695 |
| 203216_s_at | NM_004999 | MYO6 | Hs.22564 |
| 202991_at | NM_006804 | STARD3 | Hs.77628 |
| 202957_at | NM_005335 | HCLS1 | Hs.14601 |
| 202931_x_at | NM_004305 | BIN1 | Hs.193163 |
| 202902_s_at | NM_004079 | CTSS | Hs.181301 |
| 202890_at | T62571 | MAP7 | Hs.146388 |
| 202889_x_at | T62571 | MAP7 | Hs.146388 |
| 202862_at | NM_000137 | FAH | Hs.73875 |
| 202790_at | NM_001307 | CLDN7 | Hs.278562 |
| 202555_s_at | NM_005965 | MYLK | Hs.211582 |
| 202275_at | NM_000402 | G6PD | Hs.80206 |
| 202147_s_at | NM_001550 | IFRD1 | Hs.7879 |
| 202146_at | AA747426 | IFRD1 | Hs.7879 |
| 202037_s_at | NM_003012 | SFRP1 | Hs.7306 |
| 202036_s_at | AF017987.1 | SFRP1 | Hs.7306 |
| 202035_s_at | AI332407 | SFRP1 | Hs.7306 |
| 201952_at | NM_001627.1 | ALCAM | Hs.10247 |
| 201951_at | NM_001627.1 | ALCAM | Hs.10247 |
| 201858_s_at | J03223.1 | PRG1 | Hs.1908 |
| 201849_at | NM_004052 | BNIP3 | Hs.79428 |
| 201688_s_at | BE974098 | TPD52 | Hs.2384 |
| 201650_at | NM_002276 | KRT19 | Hs.182265 |
| 201644_at | NM_003313 | TSTA3 | Hs.404119 |
| 201596_x_at | NM_000224 | KRT18 | Hs.406013 |
| 201540_at | NM_001449 | FHL1 | Hs.239069 |
| 201497_x_at | NM_022844 | MYH11 | Hs.78344 |
| 201211_s_at | AF061337.1 | DDX3 | Hs.380774 |
| 201058_s_at | NM_006097 | MYL9 | Hs.9615 |
| 201030_x_at | NM_002300 | LDHB | Hs.234489 |
| 200962_at | AI348010 | — | Hs.250367 |

TABLE 4
Genes useful for separation of ESR1++,
ESRl+ ER. ESR1+ EM <-> ESR1+ FHL++.
ESR1+ FHL+. ESR1+ LM

| Affymetrix | GenBank | | |
|---|---|---|---|
| Probe Set ID HG | Accession | | |
| U133A | No | Gene Symbol | Unigene ID |
| 38158_at | D79987 | ESPL1 | Hs.153479 |
| 221900_at | AI806793 | COL8A2 | Hs.353001 |
| 221731_x_at | J02814.1 | CSPG2 | Hs.81800 |
| 221730_at | NM_000393.1 | COL5A2 | Hs.82985 |
| 221729_at | NM_000393.1 | COL5A2 | Hs.82985 |
| 221671_x_at | M63438.1 | IGKC | Hs.406565 |
| 221651_x_at | BC005332.1 | IGKC | Hs.406565 |
| 221541_at | AL136861.1 | DKF2P434B044 | Hs.262958 |
| 221530_s_at | AB044088.1 | BHLHB3 | Hs.33829 |
| 221447_s_at | NM_031302 | LOC83468 | Hs.159993 |
| 219806_s_at | NM_020179 | FN5 | Hs.259737 |
| 219561_at | NM_016429 | COPZ2 | Hs.37482 |
| 219134_at | NM_022159 | ETL | Hs.57958 |
| 219091_s_at | NM_024756 | ENDOGLYX1 | Hs.127216 |
| 218039_at | NM_016359 | ANKT | Hs.279905 |
| 218009_s_at | NM_003981 | PRC1 | Hs.344037 |
| 217890_s_at | NM_018222 | PARVA | Hs.44077 |
| 217525_at | AW305097 | — | Hs.418738 |
| 217480_x_at | M20812 | — | |
| 217428_s_at | X98568 | — | |
| 217378_x_at | X51887 | — | |
| 217281_x_at | AJ239383.1 | IGHG3 | Hs.300697 |
| 217157_x_at | AF103530.1 | IGKC | Hs.381418 |
| 217148_x_at | AJ249377.1 | IGLJ3 | Hs.102950 |
| 217022_s_at | S55735.1 | MGC27165 | Hs.153261 |
| 216984_x_at | D84143.1 | IGLJ3 | Hs.102950 |
| 216576_x_at | AF103529.1 | — | Hs.381417 |
| 216401_x_at | AJ408433 | — | |
| 216207_x_at | AW408194 | IGKV1D-13 | Hs.390427 |
| 215646_s_at | R94644 | — | Hs.81800 |
| 215446_s_at | L16895 | LOX | Hs.348385 |
| 215388_s_at | X56210.1 | HFL2 | Hs.296941 |
| 215379_x_at | AV698647 | IGLJ3 | Hs.405944 |
| 215176_x_at | AW404894 | IGKC | Hs.406565 |
| 215121_x_at | AA680302 | IGLJ3 | Hs.102950 |
| 215051_x_at | BF213829 | AIF1 | Hs.76364 |
| 214973_x_at | AJ275469 | IGHG3 | Hs.300697 |
| 214916_x_at | BG340548 | IGHM | Hs.153261 |
| 214836_x_at | BG536224 | IGKC | Hs.406565 |
| 214768_x_at | BG540628 | IGKC | Hs.406565 |
| 214677_x_at | X57812.1 | IGLJ3 | Hs.102950 |
| 214669_x_at | BG485135 | IGKC | Hs.406565 |
| 213800_at | X04697.1 | HF1 | Hs.250651 |
| 213790_at | W46291 | — | Hs.352537 |
| 213502_x_at | X03529 | LOC91316 | Hs.350074 |
| 213194_at | BF059159 | ROBO1 | Hs.301198 |
| 213139_at | AI572079 | SNAI2 | Hs.93005 |
| 213095_x_at | AF299327.1 | AIF1 | Hs.76364 |
| 213071_at | AI146848 | DPT | Hs.80552 |
| 213068_at | AI146848 | DPT | Hs.80552 |
| 213004_at | AF007150.1 | ANGPTL2 | Hs.8025 |
| 212865_s_at | BF449063 | COL14A1 | Hs.403836 |
| 212764_at | U19969.1 | TCF8 | Hs.232068 |
| 212713_at | R72286 | MFAP4 | Hs.296049 |
| 212671_s_at | BG397856 | HLA-DQA1 | Hs.198253 |
| 212609_s_at | U79271.1 | SDCCAG8 | Hs.300642 |
| 212592_at | AV733266 | IGJ | Hs.76325 |
| 212489_at | AI983428 | COL5A1 | Hs.146428 |
| 212488_at | AI983428 | COL5A1 | Hs.146428 |
| 212419_at | AL049949.1 | FLJ90798 | Hs.28264 |
| 212298_at | BE620457 | NRP1 | Hs.69285 |
| 212188_at | AF052169.1 | LOC115207 | Hs.109438 |
| 211896_s_at | AF138302.1 | DCN | Hs.433989 |
| 211813_x_at | AF138303.1 | DCN | Hs.433989 |
| 211798_x_at | AB001733.1 | IGLJ3 | Hs.102950 |
| 211645_x_at | M85256.1 | IGKC | Hs.406565 |
| 211644_x_at | L14458.1 | IGKC | Hs.406565 |
| 211643_x_at | L14457.1 | IGKC | Hs.406565 |
| 211637_x_at | L23516.1 | IGHM | Hs.153261 |
| 211571_s_at | D32039.1 | CSPG2 | Hs.81800 |
| 211368_s_at | U13700.1 | CASP1 | Hs.2490 |
| 210982_s_at | M60333.1 | HLA-DRA | Hs.76807 |
| 210904_s_at | U81380.2 | IL13RA1 | Hs.285115 |
| 210839_s_at | D45421.1 | ENPP2 | Hs.174185 |
| 210072_at | U88321.1 | CCL19 | Hs.50002 |
| 209901_x_at | U19713.1 | AIF1 | Hs.76364 |
| 209687_at | U19495.1 | CXCL12 | Hs.385710 |
| 209542_x_at | M29644.1 | IGF1 | Hs.85112 |
| 209541_at | NM_000618.1 | IGF1 | Hs.85112 |
| 209540_at | NM_000618.1 | IGF1 | Hs.85112 |
| 209496_at | BC000069.1 | RARRES2 | Hs.37682 |
| 209436_at | AB018305.1 | SPON1 | Hs.5378 |
| 209392_at | L35594.1 | ENPP2 | Hs.174185 |
| 209374_s_at | BC001872.1 | IGHM | Hs.153261 |
| 209335_at | AI281593 | DCN | Hs.433989 |
| 209138_x_at | M87790.1 | IGLJ3 | Hs.102950 |
| 209047_at | AL518391 | AQP1 | Hs.76152 |
| 208937_s_at | D13889.1 | ID1 | Hs.75424 |
| 208850_s_at | AL558479 | THY1 | Hs.125359 |
| 208747_s_at | M18767.1 | C1S | Hs.169756 |
| 208131_s_at | NM_000961 | PTGIS | Hs.302085 |
| 208079_s_at | NM_003158 | STK6 | Hs.250822 |
| 207542_s_at | NM_000385 | AQP1 | Hs.76152 |
| 207480_s_at | NM_020149 | MEIS2 | Hs.104105 |
| 207266_x_at | NM_016837 | RBMS1 | Hs.241567 |
| 207238_s_at | NM_002838 | PTPRC | Hs.170121 |
| 206584_at | NM_015364 | LY96 | Hs.69328 |
| 206102_at | NM_021067 | KIAA0186 | Hs.36232 |
| 206101_at | NM_001393 | ECM2 | Hs.35094 |
| 205941_s_at | AI376003 | COL10A1 | Hs.179729 |
| 205898_at | U20350.1 | CX3CR1 | Hs.78913 |
| 205392_s_at | NM_004166 | CCL14 | Hs.20144 |
| 205226_at | NM_006207 | PDGFRL | Hs.170040 |
| 204964_s_at | NM_005086 | SSPN | Hs.183428 |
| 204963_at | AL136756.1 | SSPN | Hs.183428 |
| 204955_at | NM_006307 | SRPX | Hs.15154 |
| 204927_at | NM_003475 | C11orf13 | Hs.72925 |
| 204897_at | NM_000958.1 | PTGER4 | Hs.199248 |
| 204619_s_at | BF590263 | CSPG2 | Hs.81800 |
| 204451_at | NM_003505 | FZD1 | Hs.94234 |
| 204359_at | NM_013231 | FLRT2 | Hs.48998 |
| 204298_s_at | NM_002317 | LOX | Hs.432618 |
| 204222_s_at | NM_006851 | GLIPR1 | Hs.64639 |
| 204115_at | NM_004126 | GNG11 | Hs.83381 |
| 204092_s_at | NM_003600 | STK6 | Hs.250822 |
| 204052_s_at | NM_003014 | SFRP4 | Hs.105700 |
| 204051_s_at | AW089415 | SFRP4 | Hs.105700 |
| 204036_at | AW269335 | EDG2 | Hs.75794 |
| 203989_x_at | NM_001992 | F2R | Hs.128087 |
| 203854_at | NM_000204 | IF | Hs.36602 |
| 203748_x_at | NM_016839 | RBMS1 | Hs.241567 |
| 203666_at | NM_000609 | CXCL12 | Hs.237356 |
| 203325_s_at | AI130969 | COL5A1 | Hs.146428 |
| 203324_s_at | NM_001233 | CAV2 | Hs.139851 |
| 203323_at | BF197655 | — | Hs.397414 |
| 203088_at | NM_006329 | FBLN5 | Hs.11494 |
| 203083_at | NM_003247 | THBS2 | Hs.108623 |
| 203065_s_at | NM_001753 | CAV1 | Hs.74034 |
| 202995_s_at | NM_006486 | FBLN1 | Hs.79732 |
| 202994_s_at | Z95331 | FBLN1 | Hs.79732 |
| 202954_at | NM_007019 | UBE2C | Hs.93002 |
| 202766_s_at | NM_000138 | FBN1 | Hs.750 |
| 202723_s_at | AW117498 | FOXO1A | Hs.170133 |
| 202705_at | NM_004701 | CCNB2 | Hs.194698 |
| 202503_s_at | NM_014736 | KIAA0101 | Hs.81892 |
| 202465_at | NM_002593 | PCOLCE | Hs.202097 |
| 202381_at | NM_003816 | ADAM9 | Hs.2442 |
| 202311_s_at | NM_000088.1 | COL1A1 | Hs.434012 |
| 202283_at | NM_002615 | SERPINF1 | Hs.173594 |
| 202238_s_at | NM_006169 | NNMT | Hs.364345 |
| 202095_s_at | NM_001168 | BIRC5 | Hs.1578 |
| 202075_s_at | NM_006227 | PLTP | Hs.283007 |
| 201787_at | NM_001996 | FBLN1 | Hs.79732 |
| 201431_s_at | NM_001387 | DPYSL3 | Hs.74566 |
| 201430_s_at | W72516 | DPYSL3 | Hs.74566 |
| 201325_s_at | NM_001423 | EMP1 | Hs.79368 |

TABLE 5
Genes useful for separation of ESR1++ <-> ESR1+ ER, ESR1+ EM

| Affymetrix | GenBank | | |
|---|---|---|---|
| Probe Set ID HG | Accession | | |
| U133A | No | Gene Symbol | Unigene ID |
| 40016_g_at | AB002301 | KIAA0303 | Hs.432631 |
| 221824_s_at | AA770170 | MGC26766 | Hs.288156 |
| 218051_s_at | NM_022908 | FLJ12442 | Hs.84753 |
| 218002_s_at | NM_004887 | CXCL14 | Hs.24395 |
| 217875_s_at | NM_020182 | TMEPAI | Hs.83883 |
| 213539_at | NM_000732.1 | CD3D | Hs.95327 |
| 213288_at | AI761250 | — | Hs.90797 |
| 213193_x_at | AL559122 | TRB@ | Hs.303157 |
| 212588_at | AI809341 | PTPRC | Hs.170121 |
| 211996_s_at | BG256504 | — | Hs.110613 |
| 210958_s_at | BC003646.1 | KIAA0303 | Hs.432631 |
| 210916_s_at | AF098641.1 | — | Hs.306278 |
| 210915_x_at | M15564.1 | TRB@ | Hs.303157 |
| 210096_at | J02871.1 | CYP4B1 | Hs.687 |
| 210072_at | U88321.1 | CCL19 | Hs.50002 |
| 209374_s_at | BC001872.1 | IGHM | Hs.153261 |
| 205831_at | NM_001767 | CD2 | Hs.89476 |
| 204897_at | NM_000958.1 | PTGER4 | Hs.199248 |
| 204655_at | NM_002985 | CCL5 | Hs.241392 |
| 204118_at | NM_001778 | CD48 | Hs.901 |
| 203895_at | AL535113 | — | Hs.348724 |
| 203868_s_at | NM_001078 | VCAM1 | Hs.109225 |
| 203439_s_at | BC000658.1 | STC2 | Hs.155223 |
| 203438_at | AI435828 | STC2 | Hs.155223 |
| 202644_s_at | NM_006290 | TNFAIP3 | Hs.211600 |
| 201422_at | NM_006332 | IFI30 | Hs.14623 |
| 201369_s_at | NM_006887 | ZFP36L2 | Hs.78909 |

TABLE 6
Genes useful for separation of ESR1+ ER <-> ESR1+ EM

| Affymetrix | GenBank | | |
|---|---|---|---|
| Probe Set ID HG | Accession | | Unigene |
| U133A | No | Gene Symbol | ID |
| 38158_at | D79987 | ESPL1 | Hs.153479 |
| 219197_s_at | AI424243 | SCUBE2 | Hs.105790 |
| 218613_at | NM_018422 | DKFZp761K1423 | Hs.236438 |
| 218469_at | NM_013372 | CKTSF1B1 | Hs.40098 |
| 218468_s_at | AF154054.1 | CKTSF1B1 | Hs.40098 |
| 217022_s_at | S55735.1 | MGC27165 | Hs.153261 |
| 216320_x_at | U37055 | — | Hs.349110 |
| 215177_s_at | AV733308 | ITGA6 | Hs.227730 |
| 212741_at | AA923354 | MAOA | Hs.183109 |
| 210559_s_at | D88357.1 | CDC2 | Hs.334562 |
| 209460_at | AF237813.1 | NPD009 | Hs.283675 |
| 209459_s_at | AF237813.1 | NPD009 | Hs.283675 |
| 209291_at | NM_001546.1 | ID4 | Hs.34853 |
| 207414_s_at | NM_002570 | PACE4 | Hs.170414 |
| 206102_at | NM_021067 | KIAA0186 | Hs.36232 |
| 203439_s_at | BC000658.1 | STC2 | Hs.155223 |
| 203438_at | AI435828 | STC2 | Hs.155223 |
| 203355_s_at | NM_015310 | EFA6R | Hs.6763 |
| 203214_x_at | NM_001786 | CDC2 | Hs.334562 |
| 203213_at | AL524035 | CDC2 | Hs.334562 |
| 201656_at | NM_000210 | ITGA6 | Hs.227730 |
| 201627_s_at | NM_005542 | INSIG1 | Hs.56205 |
| 201037_at | NM_002627 | PFKP | Hs.99910 |

TABLE 7
Genes useful for separation of ESR1+ FHL++,
ESR1+ FHL+ <-> ESR1+ LM

| Affymetrix | GenBank | | |
|---|---|---|---|
| Probe Set ID HG | Accession | | |
| U133A | No | Gene Symbol | Unigene ID |
| 222379_at | AI002715 | — | Hs.172047 |
| 222250_s_at | AK001363.1 | DKFZP434B168 | Hs.48604 |
| 222043_at | AI982754 | CLU | Hs.75106 |
| 222037_at | AI859865 | — | Hs.319215 |
| 221872_at | AI669229 | RARRES1 | Hs.82547 |
| 221796_at | AA707199 | NTRK2 | Hs.47860 |
| 221653_x_at | BC004395.1 | APOL2 | Hs.241412 |
| 221645_s_at | M27877.1 | ZNF83 | Hs.305953 |
| 221530_s_at | AB044088.1 | BHLHB3 | Hs.33829 |
| 221521_s_at | BC003186.1 | LOC51659 | Hs.433180 |
| 221188_s_at | NM_014430 | CIDEB | Hs.299867 |
| 220240_s_at | NM_017905 | C13orf11 | Hs.27337 |
| 219935_at | NM_007038 | ADAMTS5 | Hs.58324 |
| 219918_s_at | NM_018123 | ASPM | Hs.121028 |
| 219777_at | NM_024711 | hIAN2 | Hs.105468 |
| 219304_s_at | NM_025208 | SCDGF-B | Hs.112885 |
| 219077_s_at | NM_016373 | WWOX | Hs.519 |
| 218976_at | NM_021800 | JDP1 | Hs.260720 |
| 218901_at | NM_020353 | PLSCR4 | Hs.182538 |
| 218819_at | NM_012141 | DDX26 | Hs.58570 |
| 218322_s_at | NM_016234 | FACL5 | Hs.11638 |
| 218236_s_at | NM_005813 | PRKCN | Hs.143460 |
| 218039_at | NM_016359 | ANKT | Hs.279905 |
| 218009_s_at | NM_003981 | PRC1 | Hs.344037 |
| 217784_at | BE384482 | YKT6 | Hs.296244 |
| 217763_s_at | NM_006868 | RAB31 | Hs.223025 |
| 217762_s_at | BE789881 | RAB31 | Hs.223025 |
| 217179_x_at | X79782.1 | IGL@ | Hs.405944 |
| 217148_x_at | AJ249377.1 | IGLJ3 | Hs.102950 |
| 216984_x_at | D84143.1 | IGLJ3 | Hs.102950 |
| 216384_x_at | AF257099 | — | |
| 216320_x_at | U37055 | — | Hs.349110 |
| 215603_x_at | AI344075 | GGT2 | Hs.289098 |
| 215504_x_at | AF131777.1 | — | Hs.183475 |
| 214594_x_at | BG252666 | ATP8B1 | Hs.406187 |
| 214097_at | AW024383 | RPS21 | Hs.356317 |
| 214016_s_at | AL558875 | SFPQ | Hs.180610 |
| 213693_s_at | AI610869 | MUC1 | Hs.89603 |
| 213577_at | AA639705 | SQLE | Hs.71465 |
| 213554_s_at | BG257762 | H41 | Hs.283690 |
| 213158_at | AL049423.1 | — | Hs.16193 |
| 213156_at | AL049423.1 | — | Hs.16193 |
| 212981_s_at | BF791738 | — | Hs.107479 |
| 212935_at | AB002360.1 | MCF2L | Hs.25515 |
| 212915_at | AL569804 | SEMACAP3 | Hs.177635 |
| 212914_at | AV648364 | CBX7 | Hs.356416 |
| 212865_s_at | BF449063 | COL14A1 | Hs.403836 |
| 212774_at | AJ223321 | ZNF238 | Hs.69997 |
| 212494_at | AB028998.1 | TENC1 | Hs.6147 |
| 212444_at | AA156240 | — | Hs.288660 |
| 212417_at | BF058944 | SCAMP1 | Hs.31218 |
| 212259_s_at | BF344265 | HPIP | Hs.8068 |
| 212236_x_at | Z19574 | KRT17 | Hs.2785 |
| 212141_at | X74794.1 | MCM4 | Hs.154443 |
| 211698_at | AF349444.1 | CRI1 | Hs.75847 |
| 211695_x_at | AF348143.1 | MUC1 | Hs.89603 |
| 211668_s_at | K03226.1 | PLAU | Hs.77274 |
| 211597_s_at | AB059408.1 | HOP | Hs.13775 |
| 211430_s_at | M87789.1 | IGHG3 | Hs.300697 |
| 211417_x_at | L20493.1 | — | Hs.352120 |
| 210605_s_at | BC003610.1 | MFGE8 | Hs.3745 |
| 210559_s_at | D88357.1 | CDC2 | Hs.334562 |
| 210235_s_at | U22815.1 | PPFIA1 | Hs.183648 |
| 209948_at | U61536.1 | KCNMB1 | Hs.93841 |
| 209919_x_at | L20490.1 | GGTL4 | Hs.352119 |
| 209906_at | U62027.1 | C3AR1 | Hs.155935 |
| 209897_s_at | AF055585.1 | SLIT2 | Hs.29802 |
| 209791_at | AL049569 | PADI2 | Hs.33455 |
| 209708_at | AY007239.1 | DKFZP564G202 | Hs.6909 |
| 209542_x_at | M29644.1 | IGF1 | Hs.85112 |
| 209541_at | NM_000618.1 | IGF1 | Hs.85112 |
| 209540_at | NM_000618.1 | IGF1 | Hs.85112 |
| 209505_at | AI951185 | NR2F1 | Hs.374991 |
| 209351_at | BC002690.1 | KRT14 | Hs.355214 |
| 209291_at | NM_001546.1 | ID4 | Hs.34853 |
| 209040_s_at | U17496.1 | PSMB8 | Hs.180062 |
| 209016_s_at | BC002700.1 | KRT7 | Hs.23881 |
| 208932_at | BC001416.1 | PPP4C | Hs.2903 |
| 208767_s_at | AW149681 | LAPTM4B | Hs.296398 |
| 208284_x_at | NM_013421 | GGT1 | Hs.401847 |
| 208029_s_at | NM_018407 | LAPTM4B | Hs.296398 |
| 207961_x_at | NM_022870 | MYH11 | Hs.78344 |
| 207847_s_at | NM_002456 | MUC1 | Hs.89603 |
| 207480_s_at | NM_020149 | MEIS2 | Hs.104105 |
| 207131_x_at | NM_013430 | GGT1 | Hs.401847 |
| 206385_s_at | NM_020987 | ANK3 | Hs.75893 |
| 206049_at | NM_003005 | SELP | Hs.73800 |
| 205882_x_at | AI818488 | ADD3 | Hs.324470 |
| 205875_s_at | NM_016381 | TREX1 | Hs.278408 |
| 205786_s_at | NM_000632 | ITGAM | Hs.172631 |
| 205668_at | NM_002349 | LY75 | Hs.153563 |
| 205614_x_at | NM_020998 | MST1 | Hs.349110 |
| 205518_s_at | NM_003570 | CMAH | Hs.24697 |
| 205479_s_at | NM_002658 | PLAU | Hs.77274 |
| 205450_at | NM_002637 | PHKA1 | Hs.2393 |
| 205253_at | NM_002585 | PBX1 | Hs.155691 |
| 205159_at | AV756141 | CSF2RB | Hs.285401 |
| 205157_s_at | NM_000422 | KRT17 | Hs.2785 |
| 205051_s_at | NM_000222 | KIT | Hs.81665 |
| 204971_at | NM_005213 | CSTA | Hs.2621 |
| 204894_s_at | NM_003734 | AOC3 | Hs.198241 |
| 204787_at | NM_007268 | Z39IG | Hs.8904 |
| 204686_at | NM_005544 | IRS1 | Hs.96063 |
| 204641_at | NM_002497 | NEK2 | Hs.153704 |
| 204542_at | NM_006456 | STHM | Hs.288215 |
| 204455_at | NM_001723 | BPAG1 | Hs.198689 |
| 204446_s_at | NM_000698 | ALOX5 | Hs.89499 |
| 204416_x_at | NM_001645 | APOC1 | Hs.268571 |
| 204359_at | NM_013231 | FLRT2 | Hs.48998 |
| 204348_s_at | NM_013410 | AK3 | Hs.274691 |
| 204115_at | NM_004126 | GNG11 | Hs.83381 |
| 204026_s_at | NM_007057 | ZWINT | Hs.42650 |
| 204006_s_at | NM_000570 | FCGR3B | Hs.372679 |
| 203954_x_at | NM_001306 | CLDN3 | Hs.25640 |
| 203953_s_at | BE791251 | CLDN3 | Hs.25640 |
| 203892_at | NM_006103 | WFDC2 | Hs.2719 |
| 203851_at | NM_002178 | IGFBP6 | Hs.274313 |
| 203797_at | AF039555.1 | VSNL1 | Hs.2288 |
| 203749_s_at | AI806984 | RARA | Hs.361071 |
| 203726_s_at | NM_000227 | LAMA3 | Hs.83450 |
| 203698_s_at | NM_001463 | FRZB | Hs.153684 |
| 203697_at | U91903.1 | FRZB | Hs.153684 |
| 203590_at | NM_006141 | DNCLI2 | Hs.194625 |
| 203324_s_at | NM_001233 | CAV2 | Hs.139851 |
| 203214_x_at | NM_001786 | CDC2 | Hs.334562 |
| 203213_at | AL524035 | CDC2 | Hs.334562 |
| 203108_at | NM_003979 | RAI3 | Hs.194691 |
| 203065_s_at | NM_001753 | CAV1 | Hs.74034 |
| 203059_s_at | NM_004670 | PAPSS2 | Hs.274230 |
| 203038_at | NM_002844 | PTPRK | Hs.79005 |
| 202870_s_at | NM_001255 | CDC20 | Hs.82906 |
| 202765_s_at | AI264196 | FBN1 | Hs.750 |
| 202760_s_at | NM_007203 | AKAP2 | Hs.42322 |
| 202705_at | NM_004701 | CCNB2 | Hs.194698 |
| 202555_s_at | NM_005965 | MYLK | Hs.211582 |
| 202504_at | NM_012101 | TRIM29 | Hs.82237 |
| 202503_s_at | NM_014736 | KIAA0101 | Hs.81892 |
| 202242_at | NM_004615 | TM4SF2 | Hs.82749 |
| 202177_at | NM_000820 | MGC5560 | Hs.207251 |
| 201820_at | NM_000424 | KRT5 | Hs.433845 |
| 201787_at | NM_001996 | FBLN1 | Hs.79732 |
| 201753_s_at | NM_019903 | ADD3 | Hs.324470 |
| 201752_s_at | AI763123 | ADD3 | Hs.324470 |
| 201497_x_at | NM_022844 | MYH11 | Hs.78344 |
| 201461_s_at | NM_004759 | MAPKAPK2 | Hs.75074 |
| 201428_at | NM_001305 | CLDN4 | Hs.5372 |
| 201224_s_at | AU147713 | SRRM1 | Hs.18192 |
| 201212_at | D55696.1 | LGMN | Hs.18069 |
| 201195_s_at | AB018009.1 | SLC7A5 | Hs.184601 |
| 201034_at | BE545756 | ADD3 | Hs.324470 |
| 200841_s_at | AI475965 | EPRS | Hs.55921 |
| 200770_s_at | J03202.1 | LAMC1 | Hs.214982 |

TABLE 8
Genes useful for separation of ESR1+ FHL++ <-> ESR+ FHL+

| Affymetrix | GenBank | | |
|---|---|---|---|
| Probe Set ID HG | Accession | | |
| U133A | No | Gene Symbol | Unigene ID |
| 218644_at | NM_016445 | PLEK2 | Hs.39957 |
| 218451_at | NM_022842 | CDCP1 | Hs.146170 |
| 213364_s_at | AI052536 | — | Hs.31834 |
| 212914_at | AV648364 | CBX7 | Hs.356416 |
| 210052_s_at | AF098158.1 | C20orf1 | Hs.9329 |
| 209714_s_at | AF213033.1 | CDKN3 | Hs.84113 |
| 209505_at | AI951185 | NR2F1 | Hs.374991 |
| 209200_at | N22468 | MEF2C | Hs.78995 |
| 208079_s_at | NM_003158 | STK6 | Hs.250822 |
| 206754_s_at | NM_000767 | CYP2B6 | Hs.1360 |
| 204679_at | NM_002245 | KCNK1 | Hs.79351 |
| 204678_s_at | U90065.1 | KCNK1 | Hs.79351 |
| 204259_at | NM_002423 | MMP7 | Hs.2256 |
| 204092_s_at | NM_003600 | STK6 | Hs.250822 |
| 204041_at | NM_000898 | MAOB | Hs.82163 |
| 202954_at | NM_007019 | UBE2C | Hs.93002 |
| 201292_at | NM_001067.1 | TOP2A | Hs.156346 |
| 201291_s_at | NM_001067.1 | TOP2A | Hs.156346 |

### LITERATURE

(1) Publications cited: WHO. International Classification of Diseases, 10^{th} edition (ICD-10). WHO
(2) Sabin, L. H., Wittekind, C. (eds): TNM Classification of Malignant Tumors. Wiley, New York, 1997
(3) Huang E, Cheng S H, Dressman H, Pittman J, Tsou M H, Horng C F, Bild A, Iversen E S, Liao M, Chen C M, West M, Nevins J R, Huang A T. Gene expression predictors of breast cancer outcomes. Lancet, 361:1590-1596, 2003.
(4) West M, Blancehette C, Dressman H, Huang E, Ishida S, Spang R, Zuzan H, Olson J A, Markds J R, Nevins J R. Predicting the clinical status of human breast cancer by using gene expression profiles. Proc Natl Acad Sci USA, 98:11462-11467, 2001
(5) Chang J C, Wooten E C, Tsimelzon A, Hilsenbeck S G, Gutierrez M C, Elledge R, Mohsin S, Osborne C K, Chamness G C, Allred D C, O'Connell P. Gene expression profiling for the prediction of therapeutic response to docetaxel in patients with breast cancer. Lancet, 362:362-369, 2003.
(6) Goldhirsch A, Wood W C, Gelber R D, Coates A S, Thulimann B, Senn H J. Meeting Highlights: updated international expert consensus on the primary therapy of early breast cancer. J Clin Oncol 21: 3357-3365, 2003
(7) Early Breast Cancer Trialists' Collaborative Group. Polychemotherapy for early breast cancer: an overview of the randomised trials. Lancet 352: 930-942, 1998
(8) Early Breast Cancer Trialists' Collaborative Group. Tamoxifen for early breast cancer: an overview of the randomised trials. Lancet 351: 1451-1467, 1998
(9) Ganz P A, Desmond K A, Leedham B, Rowland J H, Meyerowitz B E, Belin T R. Quality of life in long-term, disease-free survivors of breast cancer: a follow-up study. J Natl Cancer Inst 94: 3949, 2002
(10) Chia S K, Speers C H, Bryce C J, Hayes M M, Olivotto I A. Ten-year outcomes in a population-based cohort of node-negative, lymphatic, and vascular invasion-negative early breast cancers without adjuvant systemic therapies. J Clin Oncol 22: 1630-1637, 2004
(11) Ayers M, Symmans W F, Stec J, Damokosh A I, Clark E, Hess K, Lecocke M, Metivier J, Booser D, Ibrahim N, Valero V, Royce M, Arun B, Whitman G, Ross J, Sneige N, Hortobagyi G N, Pusztai L. Gene expression profiles predict complete pathologic response to neoadjuvant paclitaxel and fluorouracil, doxorubicin, and cyclophosphamide chemotherapy in breast cancer. J Clin Oncol 22: 1-10, 2004
(12) Fisher E R, Costantino J, Fisher B, Redmond C. Pathologic findings from the National Surgical Adjuvant Breast Project (Protocol 4). Cancer 71: 2141-2150, 1993
(13) Shapiro C L and Recht A. Side effects of adjuvant treatment of breast cancer. N Engl J Med 344: 1997-2008, 2001
(14) Altman D G and Lyman G H. Methodological challenges in the evaluation of prognostic factors in breast cancer. Br Cancer Res Treat 52: 289-303, 1998
(15) Jatoli I, Hilsenbeck S G, Clark G M, Osborne C K. Significance of axillary lymph node metastasis in primary breast cancer. J Clin Oncol 17: 2334-2340, 1999
(16) Sorlie T, Perou C M, Tibshirani, R, Aas T, Geisler S, Johnsen H, Hastie T, Eisen M B, van de Rijn M, Jeffrey S S, Thorsen T, Quist H, Matese J C, Brown P O, Botstein D, Lonning P E, Borresen-Dale A L. Gene expression patterns of breast carcinomas distinguish tumor subclasses with clinical implications. Proc Natl Acad Sci USA 98: 10869-10874, 2001
(17) Sorlie T, Tibshirani R, Parker J, Hastie T, Marron J S, Nobel A, Deng S, Johnsen H, Pesich R, Geisler S, Demeter J, Perou C M, Lonning P E, Brown P O, Borresen-Dale A L, Botstein D. Repeated observation of breast tumor subtypes in independent gene expression data sets. Proc Natl Acad Sci USA 100: 8418-8423, 2003
(18) Van de Vijver M J, He Y D, van't Veer L J, Dai H, Hart A A M, Voskuil D W, Schreiber G J, Peterse J L, Roberts C, Marton M J, Parrish M, Atsma D, Witteveen A, Glas A, DeLahaye L, van der Velde T, Bartelink H, Rodenhuis S, Rutgers E T, Friend S H, Bernhards R. A gene-expression signature as a predictor of survival in breast cancer. N Engl J Med 347: 1999-2009, 2002
(19) Van't Veer L J, Dai H, van de Vijver M J, He Y D, Hart A A M, Mao M, Peterse H L, van der Kooy K, Marton M J, Witteveen A T, Schreiber G J, Kerkhoven R M, Roberts C, Linsley P S, Bernards R, Friend S H. Gene expression profiling predicts clinical outcome of breast cancer. Nature 415: 530-536, 2002
(20) Perou C M, Sorlie T, Eisen M B, van de Rijn M, Jeffrey S S, Rees C A, Pollack J R, Ross D T, Johnsen H, Akslen L A et al. Molecular portraits of human breast tumours. Nature 406: 747-752, 2000
(21) Golub T R, Slonim D K, Tamayo P, Huard C, Gaasenbeek M, Mesirov J P, Coller H, Loh M L, Downing J R, Caligiuri M A, Bloomfield C E, Lander E S. Molecular classification of cancer: class discovery and class prediction by gene expression monitoring. Science 286: 531-537, 1999
(22) Wang Y, Klijn J G M, Zhang Y, Sieuwerts A M, Look M P, Yang F, Talantov D, Timmermans M, Meijer-van Gelder M E, Yu J, Jatkoe T, Berns E M J J, Atkins D, Foekens J A. Lancet 365: 671-679, 2005
(23) Jatoli I, Hilsenbeck S G, Clark G M, Osborne C K. Significance of axillary lymph node metastasis in primary breast cancer. J Clin Oncol 17: 2334-2340, 1999
(24) Jansen M P H M, Foekens J A, van Staveren I L, Dirkzwager-Kiel M M, Ritstier K, Look M P, Meijer-van Gelder M E, Sieuwerts A M, Portengen H, Dorssers L C J, Klijn J G M, Berns E M J J. J Clin Oncol 23: 732-740, 2005
(25) Ma X J, Wang Z, Ryan P D, Isakoff S J, Barmettler A, Fuller A, Muir B, Mohapatra G, Salunga R, Tuggle J T et al. A two-gene expression ratio predicts clinical outcome in breast cancer patients treated with tamoxifen. Cancer Cell 5: 607-616, 2004
(26) Michiels S, Koscielny S, Hill C. Prediction of cancer outcome with microarrays: a multiple random validation strategy. Lancet 365: 488492, 2005
(27) Dressman M A, Walz T M, Lavedan C, Barnes L, Buchholtz S, Kwon I, Ellis M J, Polymeropoulos Genes that co-cluster with estrogen receptor aopha in microarray analysis of breast biopsies. Pharmacogenomics J 1:135-141, 2001
(28) Ma X J, Salunga R, Tuggle J T, Gaudet J, Enright E, McQuary P, Payette T, Pistone M, Stecker K, Zhang B M, Zhou Y X et al. Gene expression profiles of human breast cancer progression. Proc Natl Acad Sci USA 100: 5974-5979, 2003
(29) Tusher V G, Tibshirani R, Chu G. Significance analysis of microarrays applied to the ionizing radiation response. Proc Natl Acad Sci USA 98: 5116-5121, 2001
(30) Khan J, Wei J S, Ringner M, Saal L H, Ladanyi M, Westermann F, Berthold F, Schwab M, Antonescu C R, Peterson C, Meltzer P S: Classification and diagnostic prediction of cancers using gene expression profiling and artificial neural networks. Nat Med. 2001 June; 7(6):673-9.
(31) Yuh-Jye Lee, O. L. Mangasarian and W. H. Wolberg: Survival-Time Classification of Breast Cancer Patients, Data Mining Institute Technical Report 01-03, March 2001.
(32) Tibshirani R, Hastie T, Narasimhan B, Chu G. Multi-class diagnosis of cancers using shrunken centroids of gene expression. Proc Natl Acad Sci USA 99: 6567-6572, 2002
(33) Yuh-Jye Lee, Mangasarian O L, Wolberg W H. Breast Cancer Survival and Chemotherapy: A Support Vector Machine Analysis, DIMACS Series in Discrete Mathematics and Theoretical Computer Science, Vol. 55 (2000), pp. 1-10.
(34) Yuh-Jye L and Mangasarian O L: SSVM: Smooth Support Vector Machine for Classification, Computational Optimization and Applications (2001): pp. 5-22.
(35) Burke H B, Goodman PH, Rosen D B et al. Artificial neural networks improve the accuracy of cancer survival prediction. Cancer 79: 857-62, 1997
(36) Burke, H., Rosen, D., & Goodman, P. (1995) Comparing the Prediction Accuracy of Artificial Neural Networks and Other Statistical Models for Breast Cancer Survival. In Tesauro, G., Touretzky, D., & Leen, T. (Eds.), Advances in Neural Information Processing Systems, Vol. 7, pp. 1063-1067. The MIT Press
(37) Pawitan Y, Bjohle J, Wedren S, Humphreys K, Skoog L, Huang F, Amler L, Shaw P, Hall P, Bergh J. Gene expression profiling for prognosis using Cox regression. Stat Med 23:1767-80, 2004
(38) Li H, Luan Y.: Kernel Cox regression models for linking gene expression profiles to censored survival data. Pac Symp Biocomput. 2003; 65-76.
(39) Sotiriou C, Wirapati P, Loi S, Desmedt C, Harris A L, Bergh J, Smeds J, Cardoso F, Delorenzi M, Piccart M Molecular characterization of clinical grade in breast cancer (BC) challenges the existence of “grade 2” tumors. ASCO Annual Meeting, Abstract No: 506, 2005
(40) Loi S, Piccart M, Haibe-Kains B, Desmedt C, Harris A L, Bergh J, Tutt A, Miller L D, Liu ET, Sotiriou C. Prediction of early distant relapses on tamoxifen in early-stage breast cancer (BC): A potential toll for adjuvant aromatase inhibitor (AI) tailoring. ASCO Annual Meeting, Abstract No: 509, 2005
(41) Piccart M, Loi S, Van't Veer L et al. Multi-center external validation study of the Amsterdam 70-gene prognostic signature in node negative untreated breast cancer: are the results still outperforming the clinical-pathological criteria? Breast Cancer Res Treat (suppl 1), Abstract 38, 2004
(42) Paik S, Shak S, Tang G, Kim C, Baker J, Cronin M, Baehner F L, Walker M G, Watson D, Park T, Hiller W, Fisher E R, Wickerham D L, Bryant J, Wolmark N. A multigene assay to predict recurrence of tamoxifen-treated, node-negative breast cancer. N Engl J Med

1. Method of building a classificator for the classification of breast cancer samples into clinically relevant sub-classes, said method comprising
(a) collecting data on the expression level of a plurality of genes in a plurality of breast tumor samples,
(b) performing an unsupervised principle component analysis on data derived from said data collected under (a),
(c) visualizing the outcome of said principle component analysis under (b),
(d) visualizing categorical clinical information for individual samples in said visualization of step (c),
(e) identifying clinically relevant sub-classes as regions in said visualization of step (d),
(f) identifying marker genes and threshold values for expression levels of said marker genes, suitable for classification of said breast cancer samples into said clinically relevant breast cancer classes.

2. Method of claim 1, wherein said classification of said breast cancer samples is in a hierarchical classification tree.

3. Method of claim 2, wherein said hierarchical classification tree is built exclusively from binary classification steps.

4. Method of claim 1, wherein said data derived from said data collected under (a) is obtained by normalization of said collected data.

5. Method of claim 1, wherein the method further comprises filtering for genes that are technically well measurable and/or variably expressed in said plurality of breast tumor samples.

6. Method of claim 1, wherein said visualization is a visualization of a three-dimensional space, spanned by the first three principle components of said principle component analysis.

7. Method of claim 1, wherein said visualization of said categorical clinical information is by using a color code, a symbol code and/or a size code.

8. A system for building a classificator for the classification breast cancer samples into clinically relevant sub-classes, said system being adapted to perform the method of claim 1.

9. A system of claim 8, said system comprising
(a) means for performing an unsupervised principle component analysis on data derived from gene expression data,
(b) means for visualizing the outcome of said principle component analysis under (a) in a multidimensional space,
(c) means for visualizing categorical clinical information of individual samples in said visualization of (b).

10. Method for the classification of a breast cancer from a sample of said tumor, said method comprising
(a) assigning the sample to a first aggregate breast cancer class (2) if the sample is ESR(+), or to a second aggregate breast cancer class (3) if the sample is ESR(−),
(b) if said sample is in the first aggregate breast cancer class (2), then
(i) assigning the sample to a 3rd (4) or a 4th (5) aggregate breast cancer class, based on marker gene expression;
(ii) if said sample is in the 3rd aggregate breast cancer class (4), then assigning the sample to a first (8) or a second (9) elementary breast cancer class, based on marker gene expression;
(iii) if said sample is in the 4th aggregate breast cancer class (5), then assigning the sample to a third (10) or a fourth (11) elementary breast cancer class, based on marker gene expression;
(c) if said sample is in the second aggregate breast cancer class (3), then
(i) assigning the sample to a fifth (6) or a 6th (7) aggregate breast cancer class, based on marker gene expression,
(ii) if said sample is in the fifth aggregate breast cancer class (6), then assigning the sample to a fifth elementary breast cancer class (12) or a 7th aggregate breast cancer class (13), based on marker gene expression,
(iii) if said sample is in said 7th aggregate breast cancer class (13), then assigning the sample to a 6th (16) or 7th (17) elementary breast cancer class
(iv) if said sample is in said 6th aggregate breast cancer class, then assigning said sample to an 8th aggregate breast cancer class (14) or to a 10th elementary breast cancer class (15),
(v) if said sample is in said 8th aggregate breast cancer class (14), then assigning said sample to an 8th (18) or 9th (19) elementary breast cancer class.

11. Method of claim 10, wherein
(a) said assigning said sample to a 3rd (4) or 4th (5) aggregate breast cancer class is based on a bivariate classifier using the expression level of two genes selected from Table 1,
(b) said assigning said sample to a first (8) or second (9) elementary breast cancer class is based on a bivariate classifier using the expression level of two genes selected from Table 2,
(c) said assigning said sample to a 3rd (10) or 4th (11) elementary breast cancer class is based on a bivariate classifier using the expression level of two genes selected from Table 3,
(d) said assigning said sample to a 5th (6) or 6th (7) aggregate breast cancer class is based on a bivariate classifier using the expression level of two genes selected from Table 4,
(e) said assigning said sample to a 5th elementary breast cancer class (12) or a 7th aggregate breast cancer class (13) is based on a bivariate classifier using the expression level of two genes selected from Table 5,
(f) said assigning said sample to a 6th (16) or 7th (17) elementary breast cancer class is based on a bivariate classifier using the expression level of two genes selected from Table 6,
(g) said assigning said sample to an 8th aggregate breast cancer class (14) or a 10th elementary breast cancer class (15) is based on a bivariate classifier using the expression level of two genes selected from Table 7,
(h) said assigning said sample to an 8th (18) or 9th (19) elementary breast cancer class is based on a bivariate classifier using the expression level of two genes selected from Table 8.

12. Method of claim 10, wherein
(a) said assigning said sample to a 3rd (4) or 4th (5) aggregate breast cancer class is based on a bivariate classifier using the expression level of two genes selected from the group consisting of 218211_s_at, 213441_x_at, 214404_x_at, 220192_x_at and 208190_s_at, or selected from the group consisting of 219572_at, 204641_at, 207828_s_at and 219918_s_at, or selected from the group consisting of 202580_x_at, 221436_s_at, 202035_s_at, 202036_s_at and 202037_s_at;
(b) said assigning said sample to a first (8) or second (9) elementary breast cancer class is based on a bivariate classifier using the expression level of 206978_at and 203960_s_at or the absolute expression level of 204502_at and 214433_s_at, or the absolute expression level of 209374_s_at or 206133_at;
(c) said assigning said sample to a 3rd (10) or 4th (11) elementary breast cancer class is based on a bivariate classifier using the expression level of two genes selected from the group consisting of 209392_at, 210839_s_at, 209135_at and 210896_s_at, or selected from the group consisting of 219777_at and 213508_at, or selected from the group consisting of 218806_s_at, 218807_at and 208370_s_at;
(d) said assigning said sample to a 5th (6) or 6th (7) aggregate breast cancer class is based on a bivariate classifier using the absolute expression level of 208747_s_at and 38158_at, or 216401_x_at and 204222_s_at, or 214768_x_at and 202238_s_at;
(e) said assigning said sample to a 5th elementary breast cancer class (12) or a 7th aggregate breast cancer class (13) is based on a bivariate classifier using the expression level of 213288_at and 204897_at, or the expression level of two genes selected from the group consisting of 203868_s_at, 203438_at and 203439_s_at, or the expression level of 209374_s_at and 203895_at;
(f) said assigning said sample to a 6th (16) or 7th (17) elementary breast cancer class is based on a bivariate classifier using the absolute expression level of two genes selected from the group consisting of 218468_s_at, 218469_at, 203438_at and 203439_s_at, or selected from the group consisting of 201656_at, 215177_s_at and 201627_s_at, or selected from 219197_s_at and 209291_at;
(g) said assigning said sample to an 8th aggregate breast cancer class (14) or a 10th elementary breast cancer class (15) is based on a bivariate classifier using the absolute expression level of two genes selected from the group consisting of 205479_s_at, 211668_s_at, 203797_at, or selected from the group consisting of 212935_at and 212494_at, or selected from the group consisting of 221530 s_at and 202177_at;
(h) said assigning said sample to an 8th (18) or 9th (19) elementary breast cancer class is based on a bivariate classifier using the absolute expression level of two genes selected from the group consisting of 209714_s_at and 204259_at, or selected from 209200_at and 204041_at, or selected from the group consisting of 202954_at, 208079_s_at, 204092_s_at and 218644_at.
